(19) United States
(12) Patent Application Publication
(10) Pub. No.: US 2022/0041167 A1
(43) Pub. Date: Feb. 10, 2022

(54) INFORMATION PROCESSING APPARATUS, MOBILE APPARATUS, METHOD, AND PROGRAM

(71) Applicant: SONY CORPORATION, TOKYO (JP)

(72) Inventors: Ryo WATANABE, TOKYO (JP); Ryo TAKAHASHI, TOKYO (JP); Takamasa HORIBE, TOKYO (JP)

(21) Appl. No.: 17/281,415

(22) PCT Filed: Aug. 30, 2019
(86) PCT No.: PCT/JP2019/034080

§ 371 Date: Mar. 30, 2021

(30) Foreign Application Priority Data
Oct. 10, 2018 (JP) 2018-191825

(51) Int. Cl. B60W 40/076; B60W 40/13

(52) U.S. Cl. CPC B60W 40/076; B60C 23/02; B60W 40/13

(57) ABSTRACT

To achieve an information processing apparatus and a mobile apparatus that individually calculate an inclination of the mobile apparatus itself and an inclination of a traveling surface. A measurement value of an air pressure sensor that measures an air pressure of a tire of the mobile apparatus is received, and the inclination of the mobile apparatus is calculated on the basis of the tire air pressure. Furthermore, a measurement value of an absolute pressure sensor attached to the mobile apparatus is received, and an angle of the traveling surface on which the mobile apparatus travels and a position of the mobile apparatus are calculated on the basis of a horizontal movement amount of the mobile apparatus and a vertical movement amount that is calculated on the basis of the measurement value of the absolute pressure sensor. Furthermore, a plurality of different state values such as inclination information of the traveling surface that changes with time transition is input to a Kalman filter, and state values that have already been acquired are updated on the basis of the newly input state values to generate and output the latest state values.

### TECHNICAL FIELD

The present disclosure relates to an information processing apparatus, a mobile apparatus, a method, and a program. More specifically, the present disclosure relates to an information processing apparatus, a mobile apparatus, a method, and a program for calculating inclination, a position, and the like of a vehicle.

### BACKGROUND ART

As a vehicle position detection system, a global positioning system (GPS), which is a position measurement system using satellites, is known.

A traveling vehicle can confirm its own position by using the GPS. However, the GPS cannot be used in areas where radio waves from the satellites do not reach. For example, there is a problem that the GPS cannot be used in areas such as behind buildings, inside buildings, or underground parking lots.

In addition, a position measurement system using the GPS has a problem that accuracy in a height direction (z direction) is lower than that in a horizontal direction (x and y directions).

In addition, recently, a configuration in which high-accuracy three-dimensional map information successively reflecting changing traffic conditions and the like, a so-called dynamic map, is held or generated in a server and provided to a vehicle is becoming a reality. The dynamic map is expected to be used also for traveling control of an automatic driving vehicle, for example. The vehicle can confirm its own position (x, y, z) by using three-dimensional map information provided from a server.

However, at present, such high-accuracy map information is still in a trial stage and has not reached a level where it is available in all regions.

Note that, as a conventional technology that discloses a method for specifying a position of an own vehicle, Patent Document 1 (JP 2008-175716 A) can be mentioned, for example. This document discloses a technology for measuring an altitude of a vehicle by using detection information of an atmospheric pressure sensor in order to enhance accuracy of data in the height direction where accuracy of the GPS is low.

With this disclosed technology, it is possible to detect a position of a vehicle, but it is not possible to detect, for example, an inclination of the vehicle.

In recent years, an increasing number of vehicles are equipped with a camera and a driving assistance system that performs driving control, warning notification, and the like on the basis of images captured by the camera. In addition, images captured by a camera are indispensable also for automatic driving vehicles, which are expected to increase rapidly in the future. In a case where a driving control is performed on the basis of images captured by a camera in this way, it is necessary to accurately measure an optical axis of the camera. That is, it is necessary to accurately measure an inclination of a vehicle.

Patent Document 2 (JP 2009-126268 A) discloses a configuration in which an inclination in a front-rear direction of a vehicle is detected on the basis of output of an acceleration sensor attached to the vehicle.

However, this configuration has a problem that it is not possible to distinguish between a case where a traveling surface of the vehicle is inclined and a case where the vehicle itself is inclined due to loading of a load or the like.

### CITATION LIST

### Patent Document

### Patent Document 1: JP 2008-175716 A

### Patent Document 2: JP 2009-126268 A

### SUMMARY OF THE INVENTION

### Problems to be Solved by the Invention

In an embodiment of the present disclosure, an object is to provide an information processing apparatus, a mobile apparatus, a method, and a program capable of calculating an inclination of a vehicle and an inclination of a traveling surface with high accuracy even in an area where a GPS or high-accuracy three-dimensional map information cannot be used, for example.

In addition, in an embodiment of the present disclosure, an object is to provide an information processing apparatus, a mobile apparatus, a method, and a program capable of calculating a position in a height direction (Z direction) of a vehicle with high accuracy even in an area where a GPS or high-accuracy three-dimensional map information cannot be used, for example.

### Solutions to Problems

A first aspect of the present disclosure lies in

an information processing apparatus including a vehicle inclination calculation unit that

receives a tire air pressure as a measurement value of an air pressure sensor that measures an air pressure of a tire of a mobile apparatus, and

calculates an inclination of the mobile apparatus on the basis of the tire air pressure.

Furthermore, a second aspect of the present disclosure lies in

a mobile apparatus including:

an air pressure sensor that measures an air pressure of a tire of the mobile apparatus; and

a vehicle inclination calculation unit that

receives the tire air pressure as a measurement value of the air pressure sensor, and

calculates an inclination of the mobile apparatus on the basis of the tire air pressure.

Furthermore, a third aspect of the present disclosure lies in

an information processing method executed in an information processing apparatus, the information processing method including:

receiving a tire air pressure as a measurement value of an air pressure sensor that measures an air pressure of a tire of a mobile apparatus; and

calculating an inclination of the mobile apparatus on the basis of the tire air pressure,

the receiving and the calculating being performed by a vehicle inclination calculation unit.

Furthermore, a fourth aspect of the present disclosure lies in

an information processing method executed in a mobile apparatus, the information processing method including the steps of:

measuring, by an air pressure sensor, an air pressure of a tire of the mobile apparatus; and

receiving the tire air pressure as a measurement value of the air pressure sensor, and

calculating an inclination of the mobile apparatus on the basis of the tire air pressure,

the receiving and the calculating being performed by a vehicle inclination calculation unit.

Furthermore, a fifth aspect of the present disclosure lies in

a program that causes an information processing apparatus to execute information processing including:

causing a vehicle inclination calculation unit to

receive a tire air pressure as a measurement value of an air pressure sensor that measures an air pressure of a tire of a mobile apparatus, and

calculate an inclination of the mobile apparatus on the basis of the tire air pressure.

Note that the program of the present disclosure is, for example, a program that can be provided by a storage medium or a communication medium provided in a computer-readable format to an information processing apparatus or a computer system that can execute various program codes. By providing such a program in the computer-readable format, processing corresponding to the program is implemented on the information processing apparatus or the computer system.

Further objects, features, and advantages of the present disclosure will become obvious from more detailed description based on embodiments of the present disclosure as described later and the accompanying drawings. Note that, in the present specification, a system is a logical set configuration of a plurality of apparatuses and is not limited to a system in which apparatuses having respective configurations are present in the same housing.

### Effects of the Invention

According to a configuration of an embodiment of the present disclosure, an information processing apparatus and a mobile apparatus that individually calculate an inclination of the mobile apparatus itself and an inclination of a traveling surface are achieved.

Specifically, for example, a measurement value of an air pressure sensor that measures an air pressure of a tire of the mobile apparatus is received, and the inclination of the mobile apparatus is calculated on the basis of the tire air pressure. Furthermore, a measurement value of an absolute pressure sensor attached to the mobile apparatus is received, and an angle of the traveling surface on which the mobile apparatus travels and a position of the mobile apparatus are calculated on the basis of a horizontal movement amount of the mobile apparatus and a vertical movement amount that is calculated on the basis of the measurement value of the absolute pressure sensor. Furthermore, a plurality of different state values such as inclination information of the traveling surface that changes with time transition is input to a Kalman filter, and state values that have already been acquired are updated on the basis of the newly input state values to generate and output the latest state values.

With this configuration, an information processing apparatus and a mobile apparatus that individually calculate an inclination of the mobile apparatus itself and an inclination of a traveling surface are achieved.

Note that the effects described in the present specification are merely examples and are not restrictive, and additional effects may be achieved.

### BRIEF DESCRIPTION OF DRAWINGS

FIG. 1 is a diagram for describing an outline and a problem of inclination detection using an acceleration sensor.

FIG. 2 is a diagram for describing the outline and the problem of the inclination detection using the acceleration sensor.

FIG. 3 is a diagram for describing the outline and the problem of the inclination detection using the acceleration sensor.

FIG. 4 is a diagram for describing a configuration example of a vehicle which is an example of a mobile apparatus of the present disclosure.

FIG. 5 is a diagram for describing an example of traveling surface inclination detection and vehicle position calculation processing in a case where a traveling surface is inclined.

FIG. 6 is a diagram for describing an example of the traveling surface inclination detection and the vehicle position calculation processing in a case where the vehicle itself is inclined (the traveling surface is horizontal).

FIG. 7 is a diagram for describing an example of the traveling surface inclination detection and the vehicle position calculation processing in a case where the traveling surface is inclined and the vehicle itself is also inclined.

FIG. 8 is a diagram illustrating a flowchart for describing a sequence of processing executed by an information processing apparatus of the present disclosure.

FIG. 9 is a diagram for describing a configuration example of the vehicle which is an example of the mobile apparatus of the present disclosure.

FIG. 10 is a diagram for describing a correspondence between an air pressure P (Pa), which is output of an air pressure sensor, and a spring constant (damping term).

FIG. 11 is a diagram for describing a specific example of vehicle inclination calculation processing executed by the information processing apparatus.

FIG. 12 is a diagram for describing the specific example of the vehicle inclination calculation processing executed by the information processing apparatus.

FIG. 13 is a diagram illustrating a flowchart for describing a sequence of the vehicle inclination calculation processing executed by the information processing apparatus of the present disclosure.

FIG. 14 is a diagram for describing a detailed configuration example of the information processing apparatus of the present disclosure.

FIG. 15 is a diagram for describing attitude angles (roll, pitch, and yaw) around three axes of X, Y, and Z of the vehicle.

FIG. 16 is a diagram for describing a detailed configuration example of the information processing apparatus of the present disclosure.

FIG. 17 is a diagram illustrating a flowchart for describing a sequence of processing executed by the information processing apparatus of the present disclosure.

FIG. 18 is a diagram for describing a hardware configuration example of the information processing apparatus.

### MODE FOR CARRYING OUT THE INVENTION

Hereinafter, details of an information processing apparatus, a mobile apparatus, a method, and a program of the present disclosure will be described with reference to the drawings. Note that the description will be given according to the following items.

1. Outline and Problem of Inclination Detection Using Acceleration Sensor

2. Highly Accurate Traveling Surface Inclination Calculation Processing and Vehicle Position Calculation Processing

3. Highly Accurate Vehicle Inclination Detection Processing

4. Detailed Configuration Example of Information Processing Apparatus of Present Disclosure

5. Hardware Configuration Example of Information Processing Apparatus

6. Summary of Configuration of Present Disclosure

### 1. Outline and Problem of Inclination Detection Using Acceleration Sensor

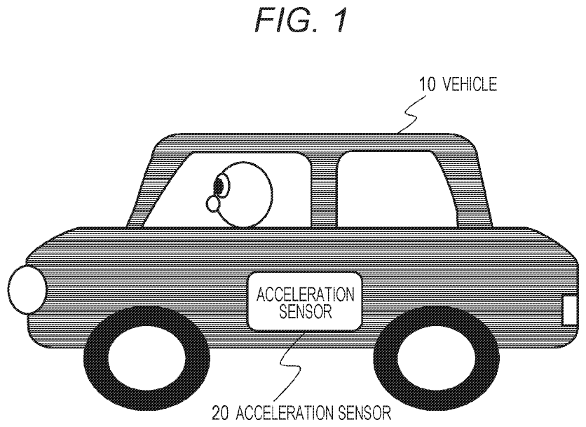

First, an outline and a problem of inclination detection using an acceleration sensor will be described with reference to FIG. 1 and the following drawings.

A configuration using an acceleration sensor to detect an inclination of a vehicle is known. In the configuration, a gravity component acquired from the acceleration sensor is detected to calculate the inclination of the vehicle from the gravity component. This configuration is also described in Patent Document 2 (JP 2009-126268 A) described above, for example. In the configuration, the inclination in a front-rear direction of the vehicle is detected on the basis of output of the acceleration sensor attached to the vehicle.

However, this configuration has a problem that it is not possible to distinguish between a case where a traveling surface of the vehicle is inclined and a case where the vehicle itself is inclined due to loading of a load or the like.

The outline and the problem of the inclination detection using the acceleration sensor will be described with reference to FIG. 1 and the following drawings.

As illustrated in FIG. 1, an acceleration sensor 20 is attached to a vehicle 10, and a gravity component detected by the acceleration sensor 20 is acquired to calculate an inclination of the vehicle.

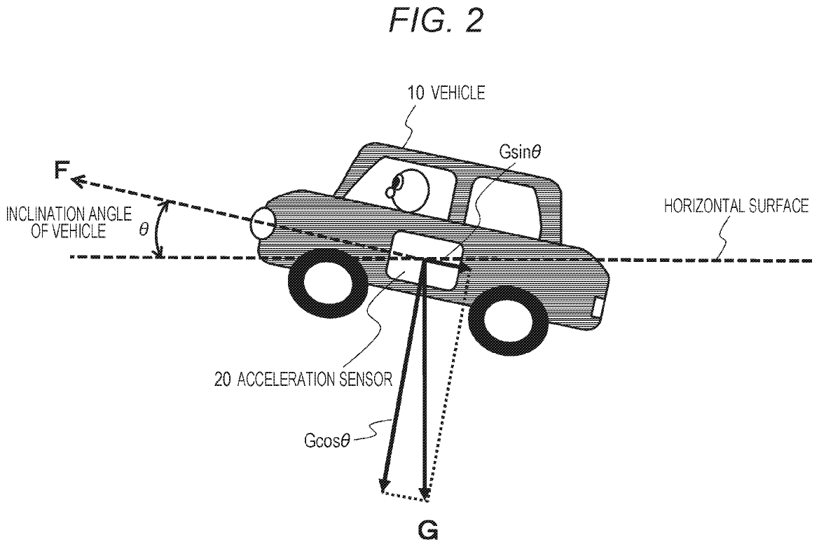

A specific processing example will be described with reference to FIG. 2.

An inclination θ of the vehicle 10 illustrated in FIG. 2 is calculated.

Acceleration g generated by travel of the vehicle is detected by the acceleration sensor 20. The acceleration g is the acceleration detected by the acceleration sensor 20.

The acceleration g is a value obtained by adding a gravitational acceleration component ge, which is acceleration in a gravity direction, to a component ga caused by fluctuation of a vehicle speed in a vehicle traveling direction F illustrated in the figure.

g=ga+ge

holds.

Here, in a case where the vehicle is traveling at a constant speed without changing the speed, the acceleration sensor 20 detects the component in the vehicle traveling direction F included in a gravitational acceleration G. When an inclination of the vehicle body 10 from a horizontal surface is θ, the component ge in the vehicle traveling direction F of the gravitational acceleration G detected by the acceleration sensor 20 can be expressed by the following equation.

ge=G·sin θ

On the other hand, in a case where acceleration A due to a change in speed is generated in the vehicle 10, the acceleration A and the component ga in the vehicle traveling direction F can be expressed by the following equation.

ga=A·cos θ

Since the acceleration g detected by the acceleration sensor 20 is

g=ga+ge

as described above, the following equation holds.

g=ga+ge=A cos θ+G sin θ

In the above equation,

the gravitational acceleration G is a fixed value,

the acceleration A is a value which can be calculated from speed change data of the vehicle, and

g is a value of the acceleration sensor 20,

all of which are known, and θ can be calculated on the basis of the above equation.

However, in this configuration for calculating an inclination of the vehicle 10 based on output of the acceleration sensor 20, there is a problem that it is not possible to distinguish between a case where a traveling surface such as a road on which the vehicle 10 travels is inclined and a case where the vehicle 10 itself is inclined due to loading of a load or the like.

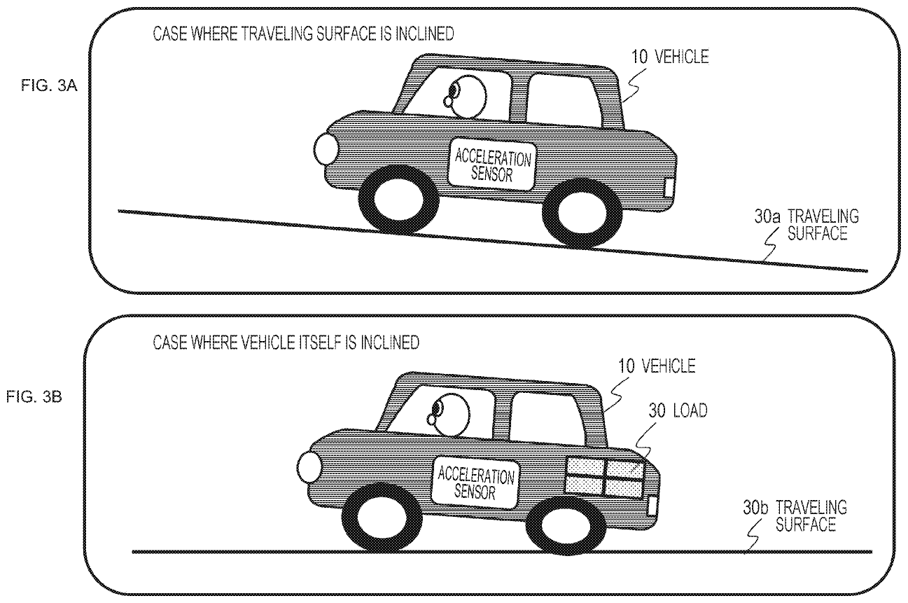

That is, there are two cases illustrated in FIG. 3 as a setting in which the vehicle is inclined.

(a) Case where a traveling surface is inclined

(b) Case where the vehicle 10 itself is inclined

The case where a traveling surface is inclined illustrated in FIG. 3(a) is an example of a case where the vehicle 10 travels on an inclined traveling surface 30a such as a slope.

On the other hand, the case where the vehicle 10 itself is inclined as illustrated in FIG. 3(b) is an example of a case where a load 30 is loaded on the vehicle 10 and the vehicle 10 is inclined by the weight of the load 30. A traveling surface 30b is a horizontal surface without inclination, but the vehicle 10 itself is inclined.

In the configuration for calculating an inclination of the vehicle 10 using the acceleration sensor 20 only, there is a problem that it is not possible to distinguish between the two cases illustrated in FIGS. 3(a) and 3(b), that is, the case where a traveling surface such as a road on which the vehicle 10 travels is inclined and the case where the vehicle 10 itself is inclined due to loading of a load or the like.

The configuration of the present disclosure solves this problem.

Note that the information processing apparatus and the mobile apparatus of the present disclosure have configurations that perform the following two types of processing.

(1) Highly accurate traveling surface inclination calculation processing and vehicle position calculation processing

(2) Highly accurate vehicle inclination calculation processing

Hereinafter, each of these types of processing will be described sequentially.

### 2. Highly Accurate Traveling Surface Inclination Calculation Processing and Vehicle Position Calculation Processing

First, highly accurate traveling surface inclination calculation processing and vehicle position calculation processing executed by the information processing apparatus and the mobile apparatus of the present disclosure will be described.

Note that the mobile apparatus of the present disclosure is not limited to an automobile such as a so-called passenger car, but also includes various mobile apparatuses such as a robot and an unmanned traveling vehicle.

Hereinafter, an example in which a vehicle (automobile) is applied as a representative example of the mobile apparatus will be described.

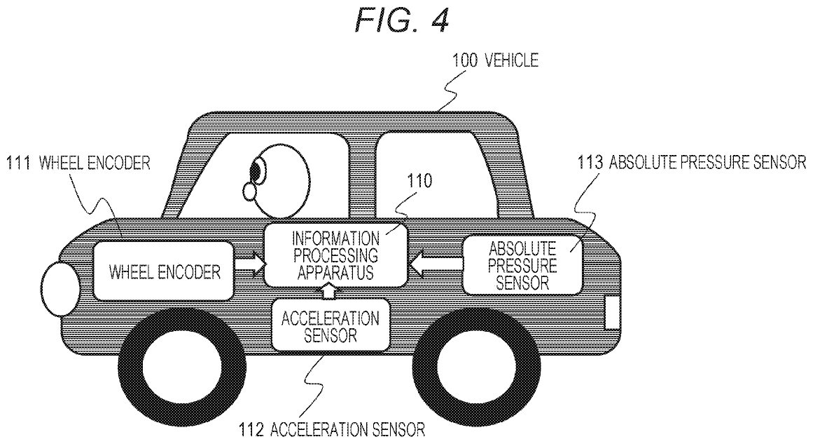

FIG. 4 illustrates a vehicle 100 which is an example of the mobile apparatus of the present disclosure. The vehicle 100 is mounted with an information processing apparatus 110 that executes the highly accurate traveling surface inclination calculation processing and vehicle position detection processing.

As illustrated in the figure, the vehicle 100 includes a wheel encoder 111, an acceleration sensor 112, and an absolute pressure sensor 113. The information processing apparatus 110 acquires an output value of at least one of these components, and executes highly accurate traveling surface inclination calculation processing and vehicle position detection processing on the basis of the acquired value.

The wheel encoder 111 calculates a moving speed of the vehicle on the basis of a rotational speed and a direction of a wheel, specifically, speeds (Vx, Vy) in x and y directions, and inputs the calculated speeds to the information processing apparatus 110.

The absolute pressure sensor 113 is a sensor that measures a pressure with a vacuum state set to zero. Specifically, the absolute pressure sensor 113 is a sensor that measures an atmospheric pressure. For example, a diaphragm type MEMS sensor or the like can be used. Note that it is also possible to use an atmospheric pressure sensor.

The absolute pressure sensor 113 measures an absolute pressure (or atmospheric pressure) P (Pa) corresponding to an altitude of the vehicle 100, and inputs the measured absolute pressure (or atmospheric pressure) P (Pa) to the information processing apparatus 110.

The acceleration sensor 112 calculates acceleration (ax, ay, az) (m/s2) of the vehicle 100 in x, y, and z directions, and inputs the calculated acceleration (ax, ay, az) (m/s2) to the information processing apparatus 110.

The information processing apparatus 110 receives output from at least any one of these components to calculate a position (x, y, z) of the vehicle 100.

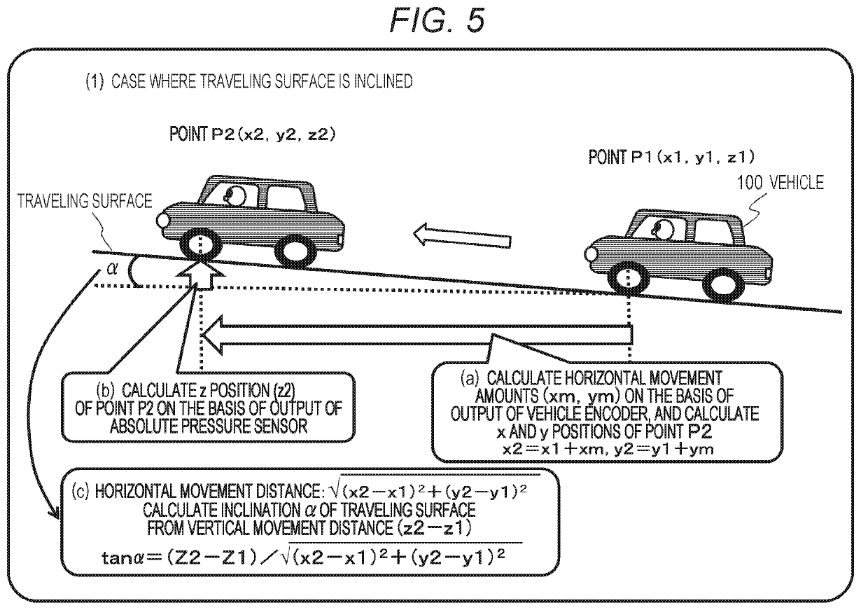

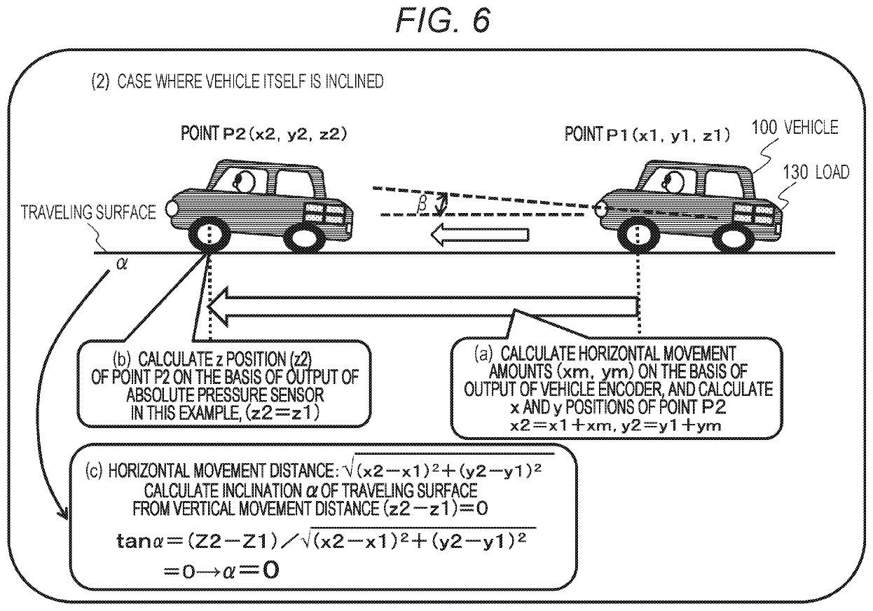

A specific example of vehicle position calculation processing will be described with reference to FIGS. 5 and 6.

FIGS. 5 and 6 each illustrate an example of traveling surface inclination detection and vehicle position calculation processing in each of the following cases.

(1) Case where a traveling surface is inclined

(2) Case where a vehicle itself is inclined (a traveling surface is horizontal)

Note that, hereinafter, a parameter indicating an inclination of a traveling surface will be denoted by α (degree (deg)), and a parameter indicating an inclination of the vehicle will be denoted by β (degree (deg)).

An inclination α of a traveling surface is an inclination of the traveling surface relative to the horizontal surface, and an inclination β of the vehicle is an inclination of the vehicle relative to a traveling surface.

First, an example of the traveling surface inclination calculation processing and the vehicle position calculation processing in the case of (1) where a traveling surface is inclined illustrated in FIG. 5.

The traveling surface is inclined at an angle α (degree (deg)) relative to the horizontal surface.

The vehicle itself is not inclined.

As illustrated in the figure, the vehicle 100 moves from a point P1 (x1, y1, z1) to a point P2 (x2, y2, z2).

The information processing apparatus 110 of the vehicle 100 has acquired position information of the point P1 (x1, y1, z1), and at a point where the vehicle 100 moves to the point P2 (x2, y2, z2), the information processing apparatus 110 calculates an inclination (α) of the traveling surface and a vehicle position (x2, y2, z2).

Note that even in a case where the position information of the point P1 (x1, y1, z1) can be acquired by, for example, position information of the GPS, but position information of the point P2 cannot be acquired from the outside such as the GPS, the information processing apparatus 110 of the vehicle 100 of the present disclosure can calculate the inclination (α) of the traveling surface and the vehicle position (x2, y2, z2) with high accuracy.

The information processing apparatus 110 of the vehicle 100 first executes processing (a) illustrated in FIG. 5.

That is, the information processing apparatus 110 receives, from the wheel encoder 111, a moving speed of the vehicle, specifically, speeds (Vx, Vy) in x and y directions. Note that the speed is time series data.

The time series speed information (Vx, Vy) is integrated to calculate movement amounts X and Y in the x and y directions from the point P1 (x1, y1, z1) to the point P2.

Furthermore, the calculated movement amounts X and Y in the x and y directions are added to x and y positions (x1, y1) of the point P1 to calculate x and y positions (x2, y2) of the point P2 according to the following equation.

(x2,y2)=(x1+X,y1+Y)

Furthermore, the information processing apparatus 110 of the vehicle 100 executes processing (b) illustrated in FIG. 5.

That is, the information processing apparatus 110 receives, from the absolute pressure sensor 113, an absolute pressure (or atmospheric pressure) P (Pa) corresponding to an altitude of the vehicle 100.

The information processing apparatus 110 holds correspondence data of an absolute pressure (or atmospheric pressure) P (Pa) and a height (z), and on the basis of the correspondence data, calculates a height corresponding to the absolute pressure P (Pa) received from the absolute pressure sensor 113, that is, a z position (z2) of the point P2.

The information processing apparatus 100 can calculate a three-dimensional position of the point P2 (x2, y2, z2) by the two types of processing (a) and (b) described above.

Furthermore, the information processing apparatus 110 of the vehicle 100 executes processing (c) illustrated in FIG. 5.

From the x and y positions (x2, y2) of the point P2 calculated in the processing (a) and the x and y positions (x1, y1) of the start point P1, a horizontal movement distance is calculated according to the following (Equation 1).

[Mathematical Formula 1]

Horizontal movement distance=\sqrt{(x2−x1)²+(y2−y1)²} (Equation 1)

Next, from the z position (z2) of the point P2 calculated in the processing (b) and a z position (z1) of the start point P1, a vertical movement distance is calculated according to the following (Equation 2).

Vertical movement distance=(Z2−Z1) (Equation 2)

Furthermore, from the horizontal movement distance calculation equation shown by (Equation 1) and the vertical movement distance calculation equation shown by (Equation 2), the following (Equation 3) is derived.

$$\begin{matrix}[ Mathematical Formula 2 ] & \\ tan α = \frac{( z 2 - z 1 )}{\sqrt{{( x 2 - x 1 )}^{2} + {( y 2 - y 1 )}^{2}}} & ( Equation 3 )\end{matrix}$$

According to this (Equation 3), tan α is calculated, and the angle α of the traveling surface can be calculated from the calculated value.

Next, an example of the traveling surface inclination calculation processing and the vehicle position calculation processing in the case of (2) where the vehicle itself is inclined (a traveling surface is horizontal) illustrated in FIG. 6.

As illustrated in FIG. 6, as in FIG. 5, the vehicle 100 moves from a point P1 (x1, y1, z1) to a point P2 (x2, y2, z2).

However, in a setting of the example of FIG. 6, unlike the example of FIG. 5, the traveling surface is horizontal and the vehicle 100 itself is inclined.

The vehicle 100 is inclined at an angle β (degree (deg)) relative to the traveling surface.

The information processing apparatus 110 of the vehicle 100 has acquired position information of the point P1 (x1, y1, z1), and at a point where the vehicle 100 moves to the point P2 (x2, y2, z2), the information processing apparatus 110 calculates an inclination (α=0) of the traveling surface and a vehicle position (x2, y2, z2).

Note that even in a case where the position information of the point P1 (x1, y1, z1) can be acquired by, for example, position information of the GPS, but position information of the point P2 cannot be acquired from the outside such as the GPS, the information processing apparatus 110 of the vehicle 100 of the present disclosure can calculate the inclination (α) of the traveling surface and the vehicle position (x2, y2, z2) with high accuracy.

The information processing apparatus 110 of the vehicle 100 first executes processing (a) illustrated in FIG. 6. This processing is similar to the processing (a) in FIG. 5.

That is, the information processing apparatus 110 receives, from the wheel encoder 111, a moving speed of the vehicle, specifically, speeds (Vx, Vy) in x and y directions. Note that the speed is time series data.

The time series speed information is integrated to calculate movement amounts (xm, ym) in the x and y directions from the point P1 (x1, y1, z1) to the point P2.

Furthermore, the calculated movement amounts (xm, ym) in the x and y directions are added to x and y positions (x1, y1) of the point P1, and x and y positions (x2, y2) of the point P2 are calculated according to the following equation.

(x2,y2)=(x1+xm,y1+ym)

Furthermore, the information processing apparatus 110 of the vehicle 100 executes processing (b) illustrated in FIG. 6.

This processing is also similar to the processing (b) in FIG. 5.

That is, the information processing apparatus 110 receives, from the absolute pressure sensor 113, an absolute pressure (or atmospheric pressure) P (Pa) corresponding to an altitude of the vehicle 100.

The information processing apparatus 110 holds correspondence data of an absolute pressure (or atmospheric pressure) P (Pa) and a height (z), and on the basis of the correspondence data, calculates a height corresponding to the absolute pressure P (Pa) received from the absolute pressure sensor 113, that is, a z position (z2) of the point P2.

In the example illustrated in FIG. 6, since a z position (z1) of the point P1 and the z position (z2) of the point P2 do not change, z2=z1 holds.

The information processing apparatus 100 can calculate a three-dimensional position of the point P2 (x2, y2, z2) by the two types of processing (a) and (b) described above.

Furthermore, the information processing apparatus 110 of the vehicle 100 executes processing (c) illustrated in FIG. 6.

From the x and y positions (x2, y2) of the point P2 calculated in the processing (a) and the x and y positions (x1, y1) of the start point P1, a horizontal movement distance is calculated according to the following (Equation 1) which is the same as that described above with reference to FIG. 5.

[Mathematical Formula 3]

Horizontal movement distance=\sqrt{(x2−x1)²+(y2−y1)²} (Equation 1)

Next, from the z position (z2) of the point P2 calculated in the processing (b) and the z position (z1) of the start point P1, a vertical movement distance is calculated according to the following (Equation 2) which is the same as that described above with reference to FIG. 5.

Vertical movement distance=(Z2−Z1) (Equation 2)

Note that, in the example illustrated in FIG. 6, the traveling surface is horizontal, and

Vertical movement distance=(Z2−Z1)=0

holds.

Furthermore, from the horizontal movement distance calculation equation shown by (Equation 1) and the vertical movement distance calculation equation shown by (Equation 2), the following (Equation 3) which is the same as that described above with reference to FIG. 5 is derived.

$$\begin{matrix}[ Mathematical Formula 4 ] & \\ tan α = \frac{( z 2 - z 1 )}{\sqrt{{( x 2 - x 1 )}^{2} + {( y 2 - y 1 )}^{2}}} & ( Equation 3 )\end{matrix}$$

According to this (Equation 3), tan α is calculated.

In the example illustrated in FIG. 6, since

Vertical movement distance=(Z2−Z1)=0

holds, a value of tan α calculated by the above (Equation 3) is 0, that is,

tan α=0

holds. As a result,

α=0

is calculated. That is, it can be determined that the traveling surface is not inclined.

In each of the examples described with reference to FIGS. 5 and 6, the vehicle is inclined relative to the horizontal surface. However, in each case of

FIG. 5=(1) a case where a traveling surface is inclined

FIG. 6=(2) a case where the vehicle itself is inclined (a traveling surface is horizontal),

an actual altitude of the vehicle 100 can be calculated with high accuracy by calculating an altitude by using a value received from the absolute pressure sensor 113.

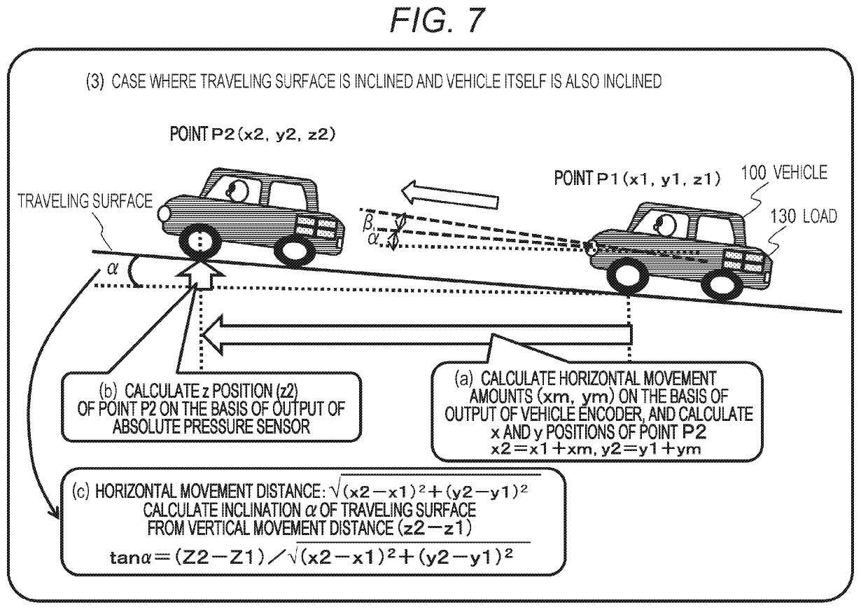

FIG. 7 illustrates an example of a case where a traveling surface is inclined and the vehicle itself is also inclined.

In the example illustrated in FIG. 7,

the traveling surface is inclined at an angle α (degree (deg)) relative to the horizontal surface, and

the vehicle 100 is inclined at an angle β (degree (deg)) relative to the traveling surface.

The inclination of the vehicle 100 is an angle (α+β) relative to the horizontal surface.

Even with such a setting, in the apparatus of the present disclosure, by executing a series of processing (a) to (c) illustrated in the figure, the inclination (α) of the traveling surface and a vehicle position (x2, y2, z2) can be calculated with high accuracy.

That is, the inclination (α) of the traveling surface and a vehicle position (x2, y2, z2) can be calculated with high accuracy by performing the processing according to the following procedure.

First, on the basis of output from the wheel encoder 111, a horizontal position (x2, y2) of a movement destination point P2 is determined, and further a horizontal movement amount is calculated according to (Equation 1) described above.

Next, on the basis of output from the absolute pressure sensor 113, a vertical position (z2) of the movement destination point P2 is determined, and further a vertical movement amount is calculated according to (Equation 2) described above.

Furthermore, by using the horizontal and vertical movement amounts, (Equation 3) described above, that is, a tan α calculation equation is generated, and the inclination (α) of the traveling surface is calculated from the tan α calculated by (Equation 3).

The inclination (α) of the traveling surface and the vehicle position (x2, y2, z2) can be calculated with high accuracy by performing these types of processing.

Note that output of the acceleration sensor 112 is not used in the processing described with reference to FIGS. 5 to 7.

When an angle is calculated by using only the output of the acceleration sensor 112, only angle information relative to the horizontal surface is output. Thus, for example,

in the case of FIG. 5, the angle α is calculated,

in the case of FIG. 6, the angle β is calculated, and

in the case of FIG. 7, the angle (α+β) is calculated.

That is, a value of an angle calculated from the output of the acceleration sensor 112 indicates an inclination of the vehicle from the horizontal surface, and an inclination of a traveling surface and the inclination of the vehicle cannot be distinguished.

In contrast, in processing of the present disclosure, an inclination of a traveling surface excluding an inclination of a vehicle can be accurately calculated.

Note that the information processing apparatus 110 of the present disclosure may be configured to perform processing using two pieces of angle information, that is,

an inclination angle α of a traveling surface calculated according to the processing described above, and

an angle (α+β) calculated from output of the acceleration sensor 112.

For example, it is possible to perform processing of calculating an inclination β of the vehicle 100 itself by subtracting the inclination angle α of the traveling surface calculated according to the processing described above from the angle (α+β) calculated from the output of the acceleration sensor 112.

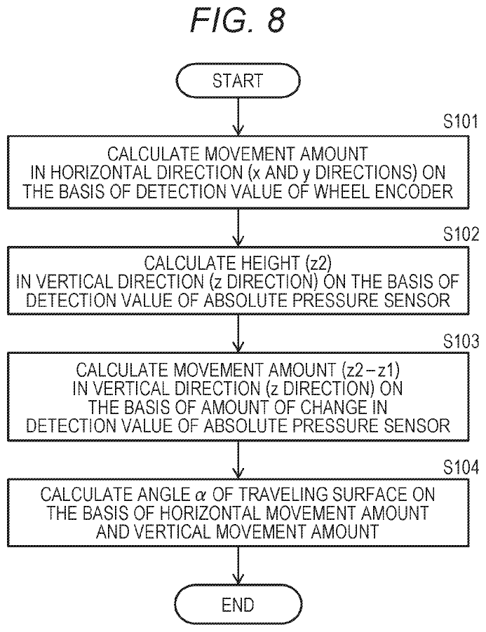

Next, a sequence of processing executed by the information processing apparatus 110 of the present disclosure will be described with reference to a flowchart illustrated in FIG. 8.

Note that the processing according to the flowchart illustrated in FIG. 8 can be executed by a control unit (data processing unit) of the information processing apparatus 110 according to a program stored in a storage unit of the information processing apparatus 110, for example. For example, the processing can be performed as program execution processing by a processor such as a CPU having a program execution function.

Hereinafter, the processing of each step of a flow illustrated in FIG. 8 will be described.

(Step S101)

First, in Step S101, the data processing unit of the information processing apparatus 110 calculates a movement amount in a horizontal direction (x and y directions) on the basis of a detection value of the wheel encoder 111.

As described above, from the wheel encoder 111, a moving speed of the vehicle, specifically, speeds (Vx, Vy) in x and y directions are input. Note that the speed is time series data.

The data processing unit of the information processing apparatus 110 integrates the time series speed information (Vx, Vy) to calculate movement amounts (xm, ym) in the x and y directions from a point P1 (x1, y1, z1) to a point P2.

Furthermore, the calculated movement amounts (xm, ym) in the x and y directions are added to x and y positions (x1, y1) of the point P1, and x and y positions (x2, y2) of the point P2 are calculated according to the following equation.

(x2,y2)=(x1+xm,y1+ym)

(Step S102)

Next, in Step S102, the data processing unit of the information processing apparatus 110 calculates a height (z2) in a vertical direction (z direction) on the basis of a detection value of the absolute pressure sensor.

That is, the data processing unit of the information processing apparatus 110 receives, from the absolute pressure sensor 113, an absolute pressure (or atmospheric pressure) P (Pa) corresponding to an altitude of the vehicle 100.

The storage unit of the information processing apparatus 110 stores correspondence data of an absolute pressure (or atmospheric pressure) P (Pa) and a height (z), and on the basis of the correspondence data, the data processing unit calculates a height corresponding to the absolute pressure P (Pa) received from the absolute pressure sensor 113, that is, a z position (z2) of the point P2.

(Step S103)

Next, in Step S103, the data processing unit of the information processing apparatus 110 calculates a movement amount (z2−z1) in the vertical direction (z direction) on the basis of an amount of change in the detection value of the absolute pressure sensor 113.

That is, the vertical movement amount (Z2−Z1) is calculated from the z position (z2) of P2 and a z position (z1) of the start point P1.

(Step S104)

Next, in Step S104, the data processing unit of the information processing apparatus 110 calculates an angle α of the traveling surface on the basis of the horizontal movement amount and the vertical movement amount.

That is, tan α is calculated by generating (Equation 3) described above, that is, a tan α calculation equation by using the horizontal movement amount calculated from the horizontal position (x2, y2) of the point P2 calculated in Step S101 and the horizontal position (x1, y2) of the start point P1, and the vertical movement amount calculated in Step S103. Furthermore, a value of the angle α, that is, an inclination angle (α (degree (deg))) of the traveling surface is calculated on the basis of the calculated value of tan α.

As described above, the information processing apparatus 110 of the present disclosure can calculate the inclination (α) of the traveling surface and the vehicle position (x2, y2, z2) with high accuracy regardless of presence or absence of the inclination of the vehicle.

### 3. Highly Accurate Vehicle Inclination Detection Processing

Next, highly accurate vehicle inclination detection processing executed by the mobile apparatus and the information processing apparatus of the present disclosure will be described.

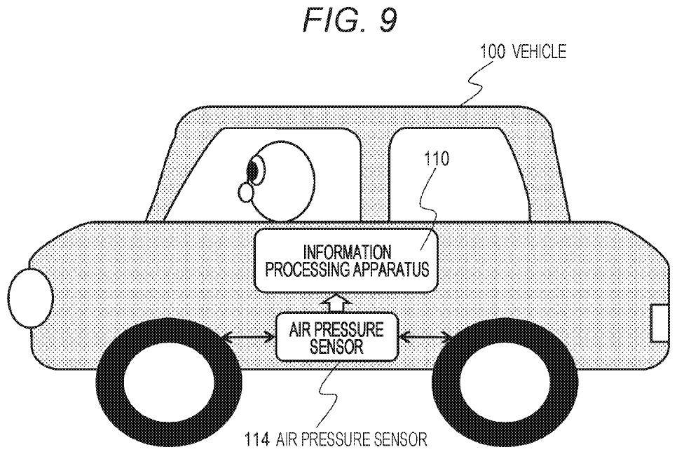

FIG. 9 illustrates the vehicle 100 which is an example of the mobile apparatus of the present disclosure. The vehicle 100 is mounted with the information processing apparatus 110 that executes the highly accurate vehicle inclination detection processing.

The vehicle 100 further includes an air pressure sensor 114, as illustrated in the figure. The information processing apparatus 110 acquires an output value of the air pressure sensor 114, and on the basis of the acquired value, detects inclination of the vehicle 100 with high accuracy.

The air pressure sensor 114 measures

an air pressure Pfront (Pa) of a front wheel of the vehicle 100 (=average of air pressures of two front wheels), and

an air pressure Prear (Pa) of a rear wheel of the vehicle 100 (=average of air pressures of two rear wheels), and

inputs these measurement values to the information processing apparatus 110.

The information processing apparatus 110 receives the output of the air pressure sensor 114, that is,

the air pressure Pfront (Pa) of the front wheel of the vehicle 100 (=average of the air pressures of the two front wheels), and

the air pressure Prear (Pa) of the rear wheel of the vehicle 100 (=average of the air pressures of the two rear wheels), and

calculates an inclination angle β (degree (deg)) of the vehicle 100.

Note that the information processing apparatus 110 converts an air pressure P (Pa), which is output of the air pressure sensor 114, into a spring constant (damping term), and calculates the inclination (β) of the vehicle 100 by using the spring constant obtained by the conversion.

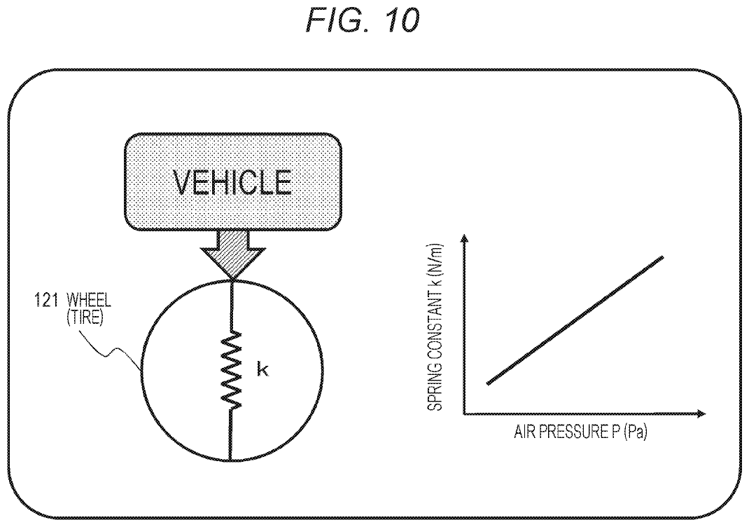

With reference to FIG. 10, a correspondence between the air pressure P (Pa), which is the output of the air pressure sensor 114, and the spring constant (damping term) will be described.

A wheel (tire) 121 is illustrated in FIG. 8. The wheel (tire) 121 can be assumed to be an elastic body having a specific spring constant k (N/m). The weight of the vehicle is applied to the wheel (tire) 121 from above, and a spring contracts according to the applied weight.

The air pressure P (Pa), which is the output of the air pressure sensor 114, and the spring constant k (N/m) are in a proportional relationship as illustrated in a graph on the right in FIG. 10.

Thus, although the air pressure P (Pa), which is the output of the air pressure sensor 114, can be used as it is to calculate the inclination (β) of the vehicle 100, a similar calculation result (inclination β of the vehicle) can be obtained also by converting the air pressure P (Pa) into the spring constant (damping term) to calculate the inclination (β) of the vehicle 100 by using the spring constant obtained by the conversion.

Note that the graph illustrated on the right in FIG. 10, that is, correspondence data of the air pressure P (Pa) and the spring constant k (N/m) is stored in a database (storage unit) in the information processing apparatus 110. The information processing apparatus 110 refers to the data stored in the database when executing the inclination calculation processing.

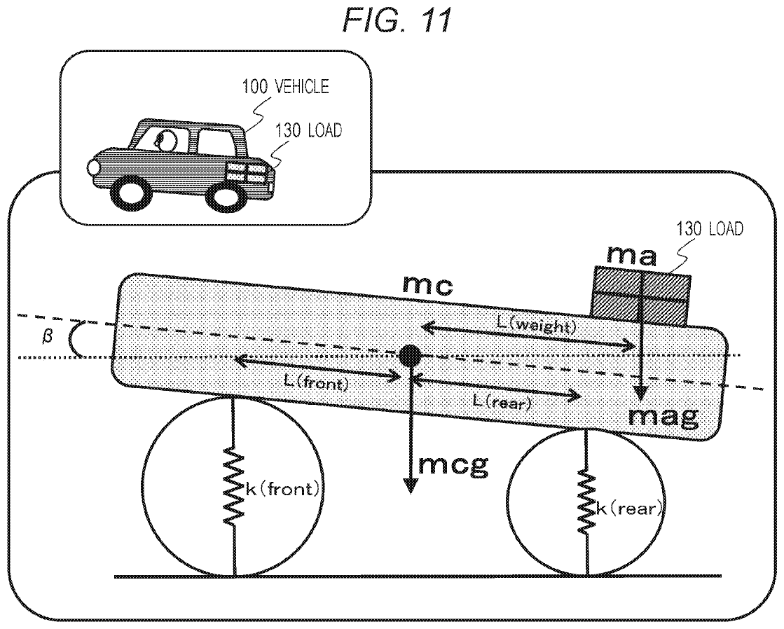

With reference to FIG. 11 and the following drawings, a specific example of the inclination calculation processing of the vehicle 100 executed by the information processing apparatus 110 will be described.

Note that, in the following description, an inclination of the vehicle 100 is an inclination β in a front-rear direction of the vehicle.

First, parameters used when the inclination β of the vehicle 100 is calculated will be described.

Note that, as illustrated in FIG. 11, the vehicle 100 is loaded with a load 130, and the load 130 causes an inclination. It is assumed that the vehicle is not inclined in a state where no load is loaded.

As illustrated in FIG. 11, the parameters used include, for example, the following parameters.

(1) β [deg]: Vehicle inclination (inclination angle in a front-rear direction of the vehicle)

(2) L(front) [m]: Distance from a center of gravity of the vehicle to the front wheel

(3) L(rear) [m]: Distance from the center of gravity of the vehicle to the rear wheel

(4) L(weight) [m]: Distance from the center of gravity of the vehicle to a center of gravity of the load

(5) k(front) [N/m]: Spring constant of a front wheel tire

(6) k(rear) [N/m]: Spring constant of a rear wheel tire

(7) mc [kg]: Vehicle weight (before loading the load)

(8) ma [kg]: Load weight

(9) g: Gravitational acceleration

Note that the center of gravity of the vehicle 100 is a known constant. In addition, L(front) and L(rear) are also known constants.

A position of the load 130 is also a fixed position (trunk position) at the rear, and is a known constant. That is, L(weight) is also a known constant.

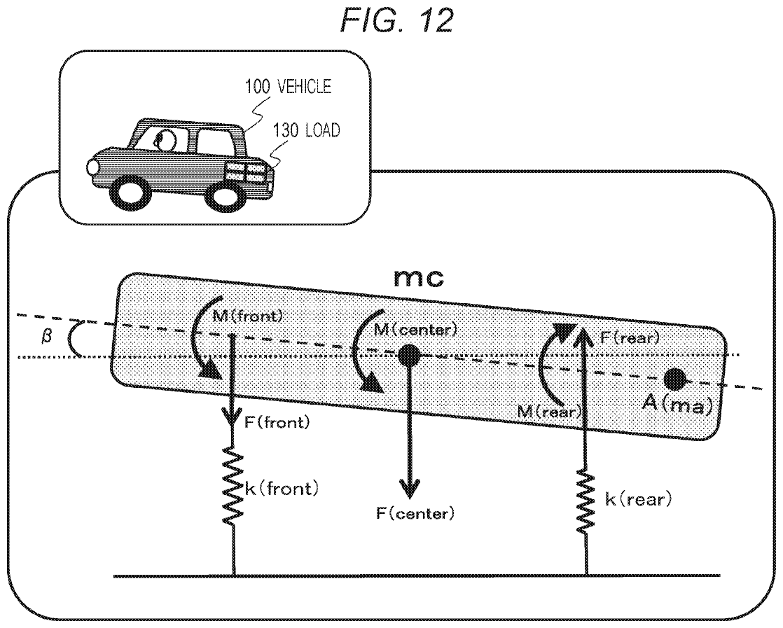

Next, with reference to FIG. 12, the specific example of the calculation processing of the inclination (β) of the vehicle 100 executed by the information processing apparatus 110 will be described.

As illustrated in FIG. 12, A is a loading position of the load (weight ma (kg)). As illustrated in FIG. 12, there are three moments centered around the point A. The moments around the point A will be analyzed.

With a clockwise moment about the point A, which is the position of the load 130, set as a left side and counterclockwise moments set as a right side, an equation showing a moment balance at rest is the following (Equation 11).

M(rear)=M(center)+M(front) (Equation 11)

The moments included in the above (Equation 11) are the following moments.

M(rear): Moment on the basis of the rear wheel tire (spring)

M(center): Moment on the basis of the center of gravity of the vehicle body

M(front): Moment on the basis of the front wheel tire (spring)

All of these are moments with the loading position A of the load (weight ma (kg)) as a center of rotation.

Note that each of these moments can be shown by the following (Equation 21) to (Equation 23) as a multiplication formula of a vertical force (F) at each moment generation position (rear wheel tire position, vehicle gravity center position, or front wheel tire position) and a distance (L) between each position and the point A.

(1) Moment to the rear wheel tire (spring)

M(rear)=F(rear)(L(weight)−L(rear)) (Equation 21)

(2) Moment to the center of gravity of the vehicle body

M(center)=F(center)(L(weight)) (Equation 22)

(3) Moment to the front wheel tire (spring)

M(front)=F(front)(L(weight)+L(front)) (Equation 23)

In addition, the vertical forces (F) at the moment generation positions (rear wheel tire position, vehicle gravity center position, and front wheel tire position), that is,

F(rear), F(center), and F(front) can be shown by the following (Equation 31) to (Equation 33).

(4) F(rear)=k(rear)(L(weight)−L(rear))sin β (Equation 31)

(5) F(center)=mcg (Equation 32)

(6) F(front)=k(front)(L(weight)+L(front))sin β (Equation 33)

Note that the spring constants can be described as functions (f(x), g(x)) with air pressures of the tires, that is, an air pressure of the front wheel tire (P(front)) and an air pressure of the rear wheel tire (P(rear)) as variables, and can be shown by the following (Equation 41) and (Equation 42).

(7) (rear)=f(P(rear)) (Equation 41)

(8) k(front)=g(P(front)) (Equation 42)

By substituting the equations shown in (1) to (8) above into the moment balance equation at rest (Equation 11) described above, that is,

M(rear)=M(center)+M(front) (Equation 11),

it is possible to generate the following (Equation 51), that is, a relational expression between the tire air pressure and the vehicle inclination.

$$\begin{matrix}[ Mathematical Formula 5 ] & \\ sin β = \frac{mcg}{\begin{matrix}f ( P ( rear ) ) {( L ( weight ) - L ( rear ) )}^{2} - \\ g ( P ( front ) ) {( L ( weight ) + L ( front ) )}^{2}\end{matrix}} & ( Equation 51 )\end{matrix}$$

A value of sin β can be calculated from this (Equation 51), and the inclination angle β (degree (deg)) of the vehicle 100 can be calculated from the calculation value.

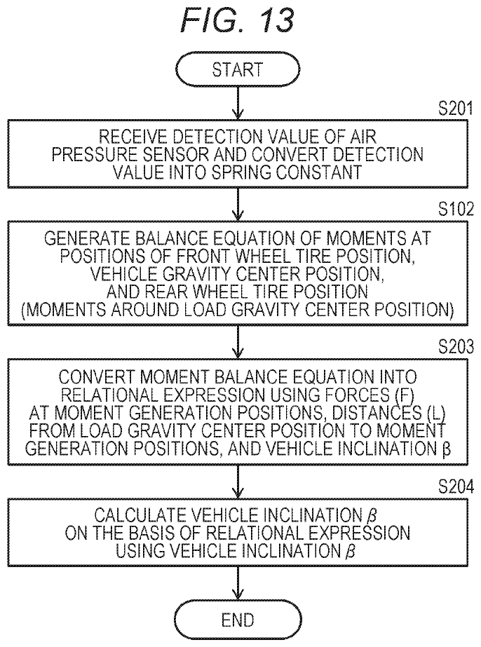

Next, processing executed by the information processing apparatus 110 of the present disclosure, that is, a sequence of the vehicle inclination calculation processing described above will be described with reference to a flowchart illustrated in FIG. 13.

Note that the processing according to the flowchart illustrated in FIG. 13 can be executed by the control unit (data processing unit) of the information processing apparatus 110 according to a program stored in the storage unit of the information processing apparatus 110, for example. For example, the processing can be performed as program execution processing by a processor such as a CPU having a program execution function.

Hereinafter, the processing of each step of a flow illustrated in FIG. 13 will be described.

(Step S201)

First, in Step S201, the data processing unit of the information processing apparatus 110 receives a measurement value, that is, an air pressure of a tire of the vehicle 100 from the air pressure sensor 114, and converts the air pressure into a spring constant k (N/m).

As described above, the air pressure sensor 114 measures

an air pressure Pfront (Pa) of the front wheel of the vehicle 100 (=average of air pressures of the two front wheels), and

an air pressure Prear (Pa) of the rear wheel of the vehicle 100 (=average of air pressures of the two rear wheels), and

inputs these measurement values to the information processing apparatus 110.

The data processing unit of the information processing apparatus 110 generates a tire model obtained by converting the received air pressure data into the spring constant k (N/m) on the basis of relation data between a tire air pressure and a spring constant stored in the storage unit. The relation data between a tire air pressure and a spring constant stored in the storage unit is data corresponding to the graph illustrated in FIG. 10.

The data processing unit of the information processing apparatus 110 uses data of

a spring constant k(front) of the front wheel of the vehicle 100 (=average of the two front wheels), and

a spring constant k(rear) of the rear wheel of the vehicle 100 (=average of the two rear wheels)

to calculate an inclination angle β (deg) of the vehicle 100 in the following steps.

(Step S202)

Next, in Step S202, the data processing unit of the information processing apparatus 110 generates a balance equation of moments at positions of a front wheel tire position, a vehicle gravity center position, and a rear wheel tire position, that is, moments around a load gravity center position.

This equation is (Equation 11) described above with reference to FIG. 12.

The equation shows a moment balance at rest with a clockwise moment about a point A, which is a position of the load 130, set as a left side, and counterclockwise moments set as a right side, and is the following (Equation 11).

M(rear)=M(center)+M(front) (Equation 11)

(Step S203)

Next, in Step S203, the data processing unit of the information processing apparatus 110 converts the moment balance equation generated in Step S202 into a relational expression using forces (F) at the moment generation positions (rear wheel tire position, vehicle gravity center position, and front wheel tire position), distances (L) from the load gravity center position to the moment generation positions, and a vehicle inclination β.

This relational expression is (Equation 51) described above with reference to FIG. 12, that is, the following (Equation 51).

$$\begin{matrix}[ Mathematical Formula 6 ] & \\ sin β = \frac{mcg}{\begin{matrix}f ( P ( rear ) ) {( L ( weight ) - L ( rear ) )}^{2} - \\ g ( P ( front ) ) {( L ( weight ) + L ( front ) )}^{2}\end{matrix}} & ( Equation 51 )\end{matrix}$$

(Step S204)

Next, in Step S204, the data processing unit of the information processing apparatus 110 calculates a vehicle inclination β on the basis of the relational expression using the vehicle inclination β generated in Step S203.

As described above, the mobile apparatus and the information processing apparatus of the present disclosure receive the air pressure of the tire measured by the air pressure sensor 114 of the vehicle 100, and calculate the inclination angle β (degree (deg)) of the vehicle.

Note that the processing according to the flow illustrated in FIG. 13 is preferably executed in a state where the vehicle 100 is stopped.

### 4. Detailed Configuration Example of Information Processing Apparatus of Present Disclosure

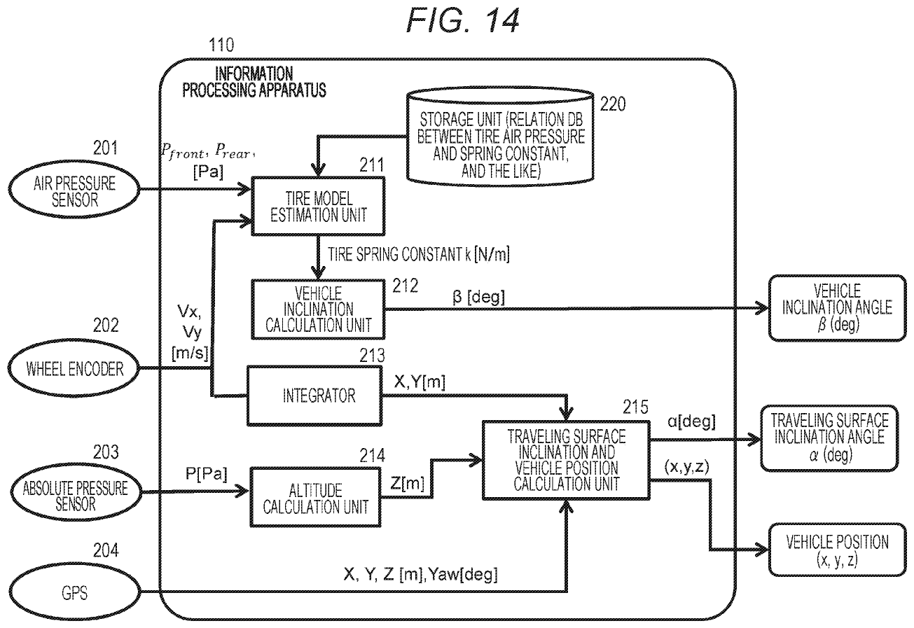

Next, a detailed configuration example of the information processing apparatus of the present disclosure will be described with reference to FIG. 14 and the following drawings.

As described above, the information processing apparatus and the mobile apparatus of the present disclosure perform the following two types of processing.

(1) Highly accurate traveling surface inclination calculation processing and vehicle position calculation processing

(2) Highly accurate vehicle inclination calculation processing

(1) Highly accurate traveling surface inclination calculation processing and vehicle position calculation processing are the processing described with reference to FIGS. 4 to 8.

(2) Highly accurate vehicle inclination calculation processing is the processing described with reference to FIGS. 9 to 13.

FIG. 14 is a diagram illustrating a configuration example of the information processing apparatus 110 capable of executing these two types of processing.

As illustrated in FIG. 14, the information processing apparatus 110 receives detection information from each component of an air pressure sensor 201, a wheel encoder 202, and an absolute pressure sensor 203.

The air pressure sensor 201 is used when an inclination angle β of the vehicle 100 is calculated as described above with reference to FIGS. 9 to 13. The air pressure sensor 201 measures

an air pressure Pfront (Pa) of the front wheel of the vehicle 100 (=average of air pressures of the two front wheels), and

an air pressure Prear (Pa) of the rear wheel of the vehicle 100 (=average of air pressures of the two rear wheels), and

inputs these measurement values to the information processing apparatus 110.

The wheel encoder 202 and the absolute pressure sensor 203 are sensors that acquire detection values used in the calculation processing of an inclination angle β of the vehicle 100 and a vehicle position described above with reference to FIGS. 4 to 8.

The wheel encoder 202 calculates a moving speed of the vehicle on the basis of a rotational speed and a direction of a wheel, specifically, speeds Vx (m/s) and Vy (m/s) in x and y directions, respectively, and inputs the calculated speeds to the information processing apparatus 110.

The absolute pressure sensor 203 is a sensor that measures a pressure with a vacuum state set to zero. Specifically, the absolute pressure sensor 203 is a sensor that measures an atmospheric pressure. For example, a diaphragm type MEMS sensor or the like can be used. Note that it is also possible to use an atmospheric pressure sensor.

The absolute pressure sensor 203 measures an absolute pressure (or atmospheric pressure) P (Pa) corresponding to an altitude of the vehicle 100, and inputs the measured pressure to the information processing apparatus 110.

A GPS 204 acquires, using satellites, position information (x, y, z) of the vehicle 100 and an attitude angle (yaw (deg)) around a Z axis, and inputs the acquired position information (x, y, z) and the attitude angle (yaw (deg)) into the information processing apparatus 110.

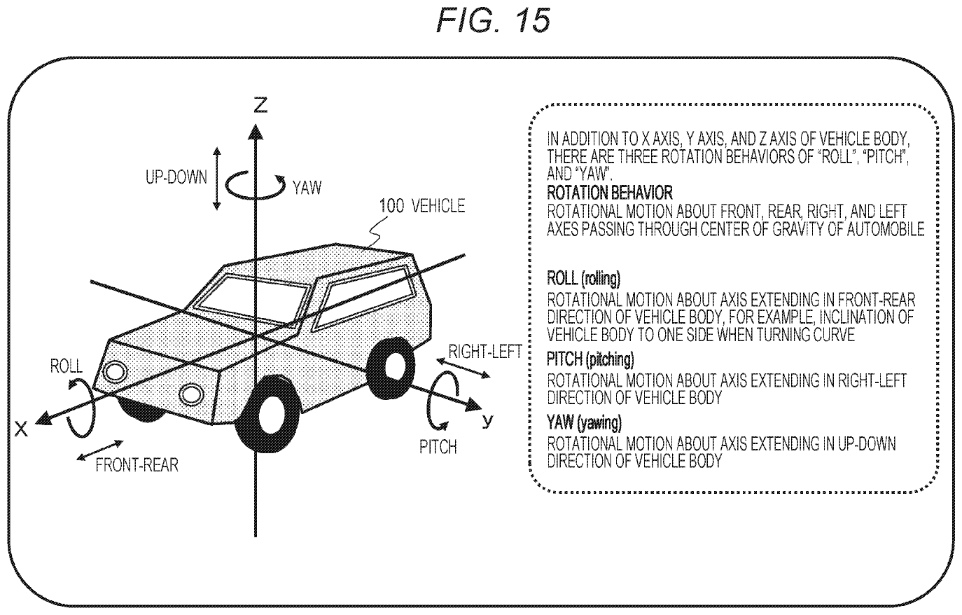

Note that attitude angles (roll, pitch, and yaw) around three axes of X, Y, and Z of the vehicle 100 is, as illustrated in FIG. 15, attitude angles around the three axes, that is, an X axis in a front-rear direction of the vehicle, a Y axis in a right-left direction of the vehicle, and the Z axis in an up-down direction of the vehicle.

The roll is the attitude angle corresponding to a rotational motion around the X axis, the pitch is the attitude angle corresponding to a rotational motion around the Y axis, and the yaw is the attitude angle corresponding to a rotational motion around the Z axis.

Next, the configuration and processing of the information processing apparatus 110 illustrated in FIG. 14 will be described.

As illustrated in FIG. 14, the information processing apparatus 110 includes a tire model estimation unit 211, a vehicle inclination calculation unit 212, an integrator 213, an altitude calculation unit 214, a traveling surface inclination and vehicle position calculation unit 215, and a storage unit 220.

The tire model estimation unit 211 receives, from the air pressure sensor 201, measurement data of air pressures of wheels, that is,

an air pressure Pfront (Pa) of the front wheel of the vehicle 100 (=average of air pressures of the two front wheels), and

an air pressure Prear (Pa) of the rear wheel of the vehicle 100 (=average of air pressures of the two rear wheels).

The tire model estimation unit 211 generates a tire model obtained by converting the received air pressure data into a spring constant k (N/m) on the basis of relation data between a tire air pressure and a spring constant stored in the storage unit 220, and outputs the generated tire model to the vehicle inclination calculation unit 212.

The relation data between a tire air pressure and a spring constant stored in the storage unit 220 is data corresponding to the graph illustrated in FIG. 10.

The tire model estimation unit 211 generates the tire model having data of

a spring constant k(front) of the front wheel of the vehicle 100 (=average of the two front wheels), and

a spring constant k(rear) of the rear wheel of the vehicle 100 (=average of the two rear wheels), and

outputs the tire model to the vehicle inclination calculation unit 212.

The vehicle inclination calculation unit 212 uses the tire model having the data of

the spring constant k(front) of the front wheel of the vehicle 100 (=average of the two front wheels), and

the spring constant k(rear) of the rear wheel of the vehicle 100 (=average of the two rear wheels),

which are received from the tire model estimation unit 211, to calculate an inclination angle β (deg) of the vehicle 100.

This processing is the processing described above with reference to FIGS. 9 to 13. That is, for example, a moment balance equation is generated, and the generated moment balance equation is solved to calculate an inclination angle β (deg) of the vehicle 100.

The integrator 213, the altitude calculation unit 214, and the traveling surface inclination and vehicle position calculation unit 215 perform the calculation processing of an inclination angle β of the vehicle 100 and a vehicle position (x, y, z) described above with reference to FIGS. 4 to 8.

The integrator 213 receives, from the wheel encoder 202, a moving speed of the vehicle, specifically, speeds (Vx, Vy) in x and y directions. Note that the speed is time series data.

The time series speed information (Vx, Vy) is integrated to calculate movement amounts X (m) and Y (m) in the x and y directions from a start point position to an end point position for calculating a traveling surface angle α (deg). Specifically, the start point position and the end point position for calculating the traveling surface angle are, for example, the points P1 and P2 illustrated in FIGS. 5 to 7. The movement amounts X (m) and Y (m) in the x and y directions from the point P1 (x1, y1, z1) to the point P2 are calculated.

The calculated movement amounts X (m) and Y (m) are output to the traveling surface inclination and vehicle position calculation unit 215.

The altitude calculation unit 214 receives, from the absolute pressure sensor 203, an absolute pressure (or atmospheric pressure) P (Pa) corresponding to an altitude of the vehicle 100. The altitude calculation unit 214 holds correspondence data of an absolute pressure (or atmospheric pressure) P (Pa) and a height (z), and on the basis of the correspondence data, calculates a height corresponding to the absolute pressure P (Pa) received from the absolute pressure sensor 203, that is, an altitude of a current point, and further, calculates a movement amount Z (m) in a z direction from the start point position to the end point position for calculating a traveling surface angle α (deg).

The movement amounts Z (m) in the z direction calculated by the altitude calculation unit 214 is output to the traveling surface inclination and vehicle position calculation unit 215.

The traveling surface inclination and vehicle position calculation unit 215 receives the values of,

from the integrator 213, the movement amounts X (m) and Y (m) in the x and y directions from the start point position to the end point position for calculating a traveling surface angle, and,

from the altitude calculation unit 214, the movement amount Z (m) in the z direction from the start point position to the end point position for calculating a traveling surface angle.

From these values, tan α is calculated according to (Equation 3) described above, that is, the following (Equation 3), and an angle α of the traveling surface is calculated from the values.

$$\begin{matrix}[ Mathematical Formula 7 ] & \\ tan α = \frac{( z 2 - z 1 )}{\sqrt{{( x 2 - x 1 )}^{2} + {( y 2 - y 1 )}^{2}}} & ( Equation 3 )\end{matrix}$$

Note that, in the above (Equation 3),

x1, y1, and z1 correspond to coordinates (x1, y1, z1) of the start point position P1 for calculating a traveling surface angle, and

x2, y2, and z2 correspond to coordinates (x2, y2, z2) of the end point position P2 for calculating a traveling surface angle.

The traveling surface inclination and vehicle position calculation unit 215 stores history data of past vehicle positions corresponding to past vehicle movement trajectories in a memory, and calculates tan α according to the above (Equation 3) by using coordinate (x1, y1, z1) information of the start point position P1 stored in the storage unit and coordinate (x2, y2, z2) information of the end point position P2 generated by adding the received movement amounts X, Y, and Z to the start point position (x1, y1, z1).

Note that the history data of the past vehicle positions corresponding to the past vehicle movement trajectories is accumulated in the memory by using a value received from the GPS 204, a value calculated by the processing described above, or data such as high-accuracy map information acquired from the outside.

By the processing described above, the information processing apparatus 110 illustrated in in FIG. 14 can output

a vehicle inclination angle β (deg),

a traveling surface inclination angle α (deg), and

a current three-dimensional position (x, y, z) of the vehicle.

Note that, as described above with reference to FIGS. 4 to 8, the information processing apparatus 110 may be configured to receive a detection value of the acceleration sensor, and calculate a total angle (α+β) of the angle α of the traveling surface and the angle β of the vehicle from the detection value of the acceleration sensor.

In the case of such a configuration, the information processing apparatus 110 can perform processing using two pieces of angle information, that is,

the inclination angle α of the traveling surface calculated according to the processing described above, and

the angle (α+β) calculated from output of the acceleration sensor 112.

For example, it is possible to perform processing of calculating an inclination β of the vehicle 100 itself by subtracting the inclination angle α of the traveling surface calculated according to the processing described above from the angle (α+β) calculated from the output of the acceleration sensor 112.

Note that, although not illustrated in FIG. 14, for example, a configuration may be adopted in which high-accuracy three-dimensional map information or the like is acquired from an external server, and information of the high-accuracy three-dimensional map information or the like is also input and applied to calculation processing of each angle and vehicle position.

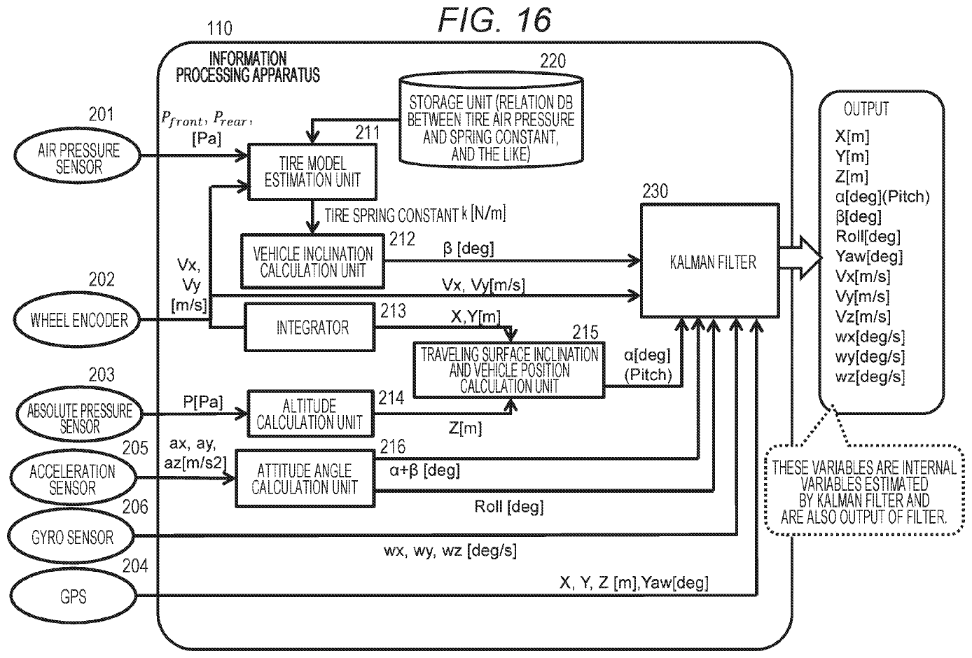

Next, a configuration example using a Kalman filter will be described with reference to FIG. 16, as another configuration example of the information processing apparatus 110 of the present disclosure.

The Kalman filter is an iterative estimator (iterative estimation filter) that receives various state values (observation values) that change with time transition and outputs estimation values of a current state. The Kalman filter is basically a linear class filter that updates state values (observation values) that have already been acquired on the basis of newly received state values (observed values), and generates and outputs the latest state values. Note that the estimation values of a state are expressed in the form of a linear combination using, for example, the state values (observation values) that have already been acquired.

As the estimation values of a state using the Kalman filter, the calculation values described above, that is,

the vehicle inclination angle β (deg),

the traveling surface inclination angle α (deg), and

the current three-dimensional position (x, y, z) of the vehicle

are output.

Note that the output of the Kalman filter includes not only the above values but also various other state values.

By using the Kalman filter, even when the vehicle 100 continues to travel, the above values, that is,

the vehicle inclination angle β (deg),

the traveling surface inclination angle α (deg), and

the current three-dimensional position (x, y, z) of the vehicle

can be output at an optional timing.

FIG. 16 is a diagram illustrating a configuration example of an information processing apparatus 110 having a Kalman filter 230. As illustrated in FIG. 16, the information processing apparatus 110 having the Kalman filter 230 can sequentially execute, similarly to the information processing apparatus 110 described above with reference to FIG. 14, the following calculation processing:

(1) highly accurate traveling surface inclination calculation processing and vehicle position calculation processing; and

(2) highly accurate vehicle inclination calculation processing

in time series while the vehicle is traveling, and can sequentially output other state quantities.

As illustrated in FIG. 16, the information processing apparatus 110 receives detection information from each component of an acceleration sensor 205 and a gyro sensor 206, in addition to an air pressure sensor 201, a wheel encoder 202, an absolute pressure sensor 203, and a GPS 204.

The air pressure sensor 201 is used when an inclination angle β of the vehicle 100 is calculated as described above with reference to FIGS. 9 to 13. The air pressure sensor 201 measures

an air pressure Pfront (Pa) of the front wheel of the vehicle 100 (=average of air pressures of the two front wheels), and

an air pressure Prear (Pa) of the rear wheel of the vehicle 100 (=average of air pressures of the two rear wheels), and

inputs these measurement values to the information processing apparatus 110.

The wheel encoder 202 and the absolute pressure sensor 203 are used when an inclination angle β of the vehicle 100 is calculated as described above with reference to FIGS. 4 to 8.

The wheel encoder 202 calculates a moving speed of the vehicle on the basis of a rotational speed and a direction of a wheel, specifically, speeds Vx (m/s) and Vy (m/s) in x and y directions, respectively, and inputs the calculated speeds to the information processing apparatus 110.

The absolute pressure sensor 203 is a sensor that measures a pressure with a vacuum state set to zero. Specifically, the absolute pressure sensor 203 is a sensor that measures an atmospheric pressure. For example, a diaphragm type MEMS sensor or the like can be used. Note that it is also possible to use an atmospheric pressure sensor.

The absolute pressure sensor 203 measures an absolute pressure (or atmospheric pressure) P (Pa) corresponding to an altitude of the vehicle 100, and inputs the measured pressure to the information processing apparatus 110.

The GPS 204 acquires, using satellites, position information (x, y, z) of the vehicle 100 and an attitude angle (yaw (deg)) around a Z axis, and inputs the acquired position information (x, y, z) and the attitude angle (yaw (deg)) into the information processing apparatus 110.

The acceleration sensor 205 calculates acceleration (ax, ay, az) (m/s2) of the vehicle 100 in x, y, and z directions, and inputs the calculated acceleration (ax, ay, az) (m/s2) to the information processing apparatus 110.

The gyro sensor 206 calculates angular speeds (wx, wy, wz) (deg/s) of the vehicle 100 in the x, y, and z directions, and inputs the calculated angular speeds (wx, wy, wz) (deg/s) to the information processing apparatus 110.

Next, the configuration and processing of the information processing apparatus 110 illustrated in FIG. 16 will be described.

As illustrated in FIG. 16, the information processing apparatus 110 includes a tire model estimation unit 211, a vehicle inclination calculation unit 212, an integrator 213, an altitude calculation unit 214, a traveling surface inclination and vehicle position calculation unit 215, an attitude angle calculation unit 216, a storage unit 220, and the Kalman filter 230.

The tire model estimation unit 211 receives, from the air pressure sensor 201, measurement data of air pressures of wheels, that is,

an air pressure Pfront (Pa) of the front wheel of the vehicle 100 (=average of air pressures of the two front wheels), and

an air pressure Prear (Pa) of the rear wheel of the vehicle 100 (=average of air pressures of the two rear wheels).

Processing executed by the tire model estimation unit 211 to the traveling surface inclination and vehicle position calculation unit 215 is similar to that described above with reference to FIG. 14.

However, in the configuration illustrated in FIG. 16, all the values calculated by the vehicle inclination calculation unit 212 and the traveling surface inclination and vehicle position calculation unit 215 are input to the Kalman filter 230.

The attitude angle calculation unit 216 receives a detection value of the acceleration sensor 205, that is, acceleration (ax, ay, az) (m/s2) of the vehicle 100 in the x, y, and z directions.

The attitude angle calculation unit 216 calculates, on the basis of the acceleration (ax, ay, az) (m/s2) of the vehicle 100 in the x, y, and z directions, a total angle (α+β) of a traveling surface angle α and a vehicle inclination angle β. Furthermore, the attitude angle calculation unit 216 also calculates a roll angle of the vehicle 100, that is, a rotation angle Roll (deg) around an x axis in a front-rear direction of the vehicle described with reference to FIG. 15.

These calculation values are input to the Kalman filter 230.

The Kalman filter 230 receives the following variables (state values).

(1) Vehicle inclination angle β (deg) as a calculation value of the vehicle inclination calculation unit 212,

(2) Speeds Vx (m/s) and Vy (m/s) in the x and y directions as measurement values of the wheel encoder 202,

(3) Traveling surface inclination angle α (deg) (=pitch) as a calculation value of the traveling surface inclination and vehicle position calculation unit 215,

(4) Total angle (α+β) of the traveling surface angle α and the vehicle inclination angle β, as a calculation value of the attitude angle calculation unit 216,

(5) Roll angle Roll (deg) of the vehicle as a calculation value of the attitude angle calculation unit 216,

(6) Angular speeds (wx, wy, wz) (deg/s) in the x, y, and z directions of the vehicle, as detection values of the gyro sensor 206, and

(7) Position information (x, y, z) of the vehicle and an attitude angle around the Z axis (yaw (deg)) as detection values of the GPS 204

The Kalman filter 230 sequentially receives each of these state values as time series data. The Kalman filter 230 receives each of the state values (observation values) described above that change with time transition, updates state values (observation values) that have already been acquired on the basis of the received state values (observation values), and generates and outputs the latest state values corresponding to each time.

The output state values are the state values corresponding to the above (1) to (7). These state values also include the calculation values described above, that is,

the vehicle inclination angle β (deg),

the traveling surface inclination angle α (deg), and

the current three-dimensional position (x, y, z) of the vehicle.

As illustrated in FIG. 16, by using the Kalman filter 230, even when the vehicle 100 continues to travel, the above values, that is,

the vehicle inclination angle β (deg),

the traveling surface inclination angle α (deg), and

the current three-dimensional position (x, y, z) of the vehicle

can be output at an optional timing.

Note that, although not illustrated in FIG. 16, for example, a configuration may be adopted in which high-accuracy three-dimensional map information or the like is acquired from an external server, and information of the high-accuracy three-dimensional map information or the like is also input to the Kalman filter 230 and applied to calculation and update of each state value.

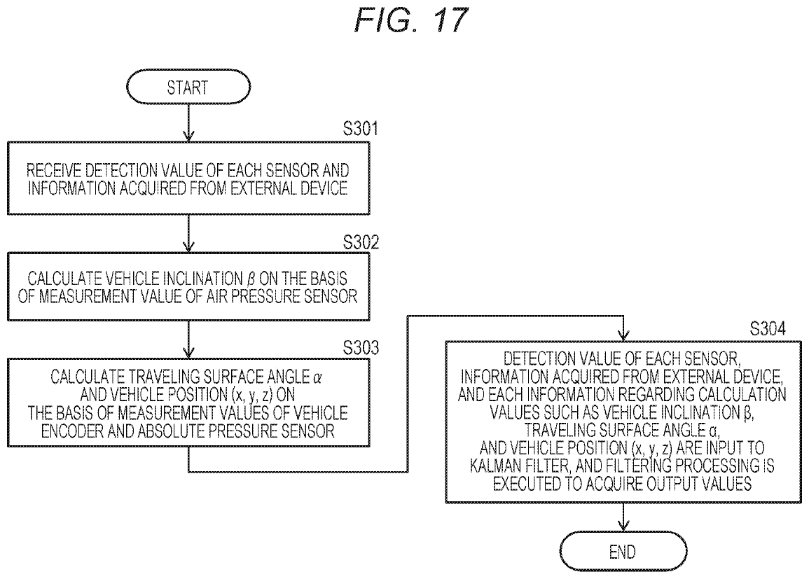

Next, a sequence of processing executed by the information processing apparatus 110 illustrated in FIG. 16 will be described with reference to a flowchart illustrated in FIG. 17.

Note that the processing according to the flowchart illustrated in FIG. 17 can be executed by a control unit (data processing unit) of the information processing apparatus 110 according to a program stored in the storage unit of the information processing apparatus 110, for example. For example, the processing can be performed as program execution processing by a processor such as a CPU having a program execution function.

Hereinafter, the processing of each step of a flow illustrated in FIG. 17 will be described.

(Step S301)

First, in Step S301, the information processing apparatus 110 receives a detection value of each sensor and information acquired from an external device.

That is, reception processing of each detection value of the acceleration sensor 205 and the gyro sensor 206, in addition to the air pressure sensor 201, the wheel encoder 202, the absolute pressure sensor 203, and the GPS 204 illustrated in FIG. 16, and high-accuracy three-dimensional map information from an external server is executed.

(Step S302)

Next, in Step S302, the information processing apparatus 110 calculates a vehicle inclination β (deg) on the basis of a measurement value of the air pressure sensor 201.

This processing is executed by the vehicle inclination calculation unit 212 illustrated in FIG. 16.

The vehicle inclination calculation unit 212 uses a tire model having data of

a spring constant k(front) of the front wheel of the vehicle 100 (=average of the two front wheels), and

a spring constant k(rear) of the rear wheel of the vehicle 100 (=average of the two rear wheels),

which are received from the tire model estimation unit 211, to calculate an inclination angle β (deg) of the vehicle 100.

This processing is the processing described above with reference to FIGS. 9 to 13. That is, for example, a moment balance equation is generated, and the generated moment balance equation is solved to calculate an inclination angle β (deg) of the vehicle 100.

(Step S303)

Next, in Step S303, the information processing apparatus 110 calculates a traveling surface angle α (deg) and a current position (x, y, z) of the vehicle on the basis of detection values of the wheel encoder 111 and the absolute pressure sensor 203.

This processing is executed by the traveling surface inclination and vehicle position calculation unit 215 illustrated in FIG. 16.

The traveling surface inclination and vehicle position calculation unit 215 receives values of,

from the integrator 213, movement amounts X (m) and Y (m) in the x and y directions from a start point position to an end point position for calculating a traveling surface angle, and,

from the altitude calculation unit 214, a movement amount Z (m) in the z direction from the start point position to the end point position for calculating a traveling surface angle.

From these values, tan α is calculated according to (Equation 3) described above, that is, the following (Equation 3), and an angle α of the traveling surface is calculated from the values.

The traveling surface inclination and vehicle position calculation unit 215 stores history data of past vehicle positions corresponding to past vehicle movement trajectories in a memory, and generates coordinate (x1, y1, z1) information of a start point position P1 stored in the storage unit and coordinates (x2, y2, z2) of an end point position P2 generated by adding the received movement amounts X, Y, and Z to the start point position (x1, y1, z1).

(Step S304)

Step S304 is state value update processing to which the Kalman filter 230 is applied.

A detection value of each sensor, information acquired from an external device, and

each information regarding calculation values such as the vehicle inclination β, the traveling surface angle α, and the vehicle position (x, y, z) are input to the Kalman filter 230, and filtering processing is executed to generate and output output values, that is, the latest state values.

By using the Kalman filter 230, even when the vehicle 100 continues to travel, the latest data of various state values including

the vehicle inclination angle β (deg),

the traveling surface inclination angle α (deg), and

the current three-dimensional position (x, y, z) of the vehicle

can be acquired at an optional timing.

### 5. Hardware Configuration Example of Information Processing Apparatus

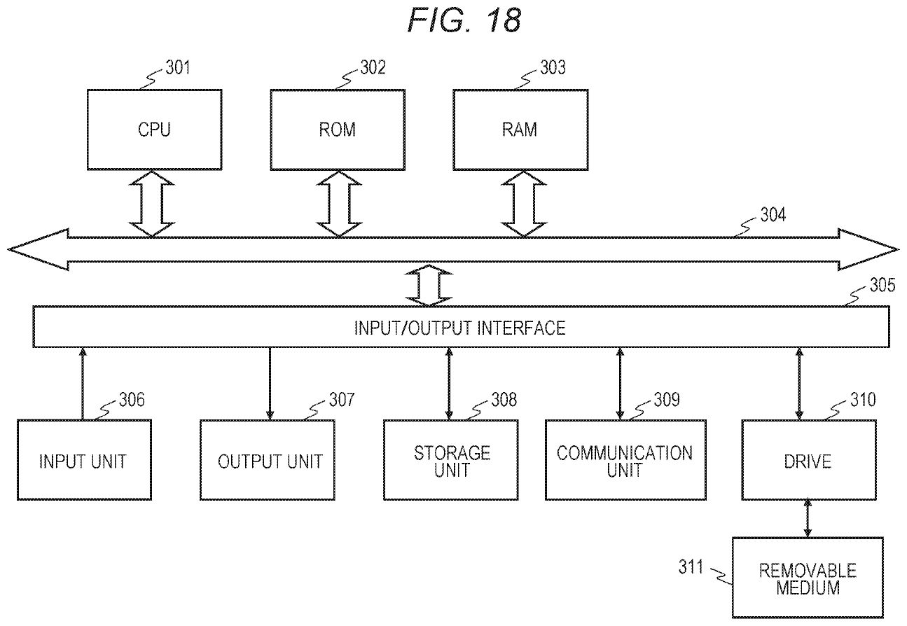

Next, a hardware configuration example of the information processing apparatus 110 will be described with reference to FIG. 18. FIG. 18 is a diagram illustrating an example of the hardware configuration of the information processing apparatus 110.

A central processing unit (CPU) 301 functions as a data processing unit that executes various types of processing according to a program stored in a read only memory (ROM) 302 or a storage unit 308. For example, the CPU 301 executes processing according to the sequence described in the above-described embodiment. A random access memory (RAM) 303 stores a program executed by the CPU 301, data, and the like. The CPU 301, the ROM 302, and the RAM 303 are connected to each other by a bus 304.

The CPU 301 is connected to an input/output interface 305 via the bus 304, and the input/output interface 305 is connected to an input unit 306 including various switches, a keyboard, a touch panel, a mouse, and a microphone, and an output unit 307 including a display and a speaker.

Detection information of various sensors is also input to the input unit 306.

The storage unit 308 connected to the input/output interface 305 includes a hard disk, for example, and stores a program executed by the CPU 301 and various types of data. A communication unit 309 functions as a transmission/reception unit for data communication via a network such as the Internet and a local area network, and communicates with an external device.

A drive 310 connected to the input/output interface 305 drives a removable medium 311 such as a magnetic disk, an optical disk, a magneto-optical disk, or a semiconductor memory like a memory card, and executes recording or reading of data.

### 6. Summary of Configuration of Present Disclosure

The embodiments of the present disclosure have been described above in detail with reference to the specific embodiments. However, it is obvious that those skilled in the art can modify or substitute the embodiments without departing from the subject matter of the present disclosure. That is, the present disclosure has been disclosed by way of exemplification and shall not be interpreted restrictively. The appended claims should be taken into consideration for determining the subject matter of the present disclosure.

Note that the technology disclosed in the present specification can have the following configurations.

(1) An information processing apparatus including a vehicle inclination calculation unit that

receives a tire air pressure as a measurement value of an air pressure sensor that measures an air pressure of a tire of a mobile apparatus, and

calculates an inclination of the mobile apparatus on the basis of the tire air pressure.

(2) The information processing apparatus according to (1), further including

a traveling surface inclination calculation unit that

receives a measurement value of an absolute pressure sensor attached to the mobile apparatus, and

calculates an angle of a traveling surface on which the mobile apparatus travels on the basis of a movement amount including a horizontal component of the mobile apparatus and a vertical movement amount that is calculated on a basis of the measurement value of the absolute pressure sensor.

(3) The information processing apparatus according to (2), further including

a position calculation unit that calculates a current position of the mobile apparatus on the basis of the movement amount including the horizontal component of the mobile apparatus and the vertical movement amount.

(4) The information processing apparatus according to any one of (1) to (3), in which

the vehicle inclination calculation unit receives,

from the air pressure sensor,

an average of air pressures of front wheel tires of the mobile apparatus, and

an average of air pressures of rear wheel tires of the mobile apparatus,

calculates, on the basis of the received values, a spring constant of the front wheel tire and a spring constant of the rear wheel tire, and calculates the inclination of the mobile apparatus by using the calculated spring constants.

(5) The information processing apparatus according to any one of (1) to (4), in which

the vehicle inclination calculation unit generates a balance equation of moments at a plurality of different portions of the mobile apparatus, and calculates the inclination of the mobile apparatus by using the generated balance equation of the moments.

(6) The information processing apparatus according to (5), in which

the moments are moments around a position of a load loaded on the mobile apparatus, and

include moments at three positions of the mobile apparatus, that is, a center of gravity position, a front wheel tire position, and a rear wheel tire position.

(7) The information processing apparatus according to any one of (1) to (6), in which

a GPS measurement value or high-accuracy map information is acquired, and an angle of a traveling surface of the mobile apparatus or a current position of the mobile apparatus is calculated by using the acquired information.

(8) The information processing apparatus according to any one of (1) to (8), further including a Kalman filter,

in which the Kalman filter receives a plurality of different state values that changes with time transition, updates state values that have already been acquired on the basis of the newly received state values, and generates and outputs latest state values.

(9) The information processing apparatus according to (8), in which

the Kalman filter receives a detection value of an acceleration sensor, and applies the received detection value of the acceleration sensor to calculate and output a latest state value.

(10) The information processing apparatus according to (8), in which

an output value of the Kalman filter includes at least one of state values including

an inclination angle β of the mobile apparatus,

a traveling surface inclination angle α of the mobile apparatus, and

a current three-dimensional position (x, y, z) of the mobile apparatus.

(11) A mobile apparatus including:

an air pressure sensor that measures an air pressure of a tire of the mobile apparatus; and

a vehicle inclination calculation unit that

receives the tire air pressure as a measurement value of the air pressure sensor, and

calculates an inclination of the mobile apparatus on the basis of the tire air pressure.

(12) The mobile apparatus according to (11), further including:

an absolute pressure sensor that measures an absolute pressure; and

a traveling surface inclination calculation unit that

receives a measurement value of the absolute pressure sensor, and

calculates an angle of a traveling surface on which the mobile apparatus travels on the basis of a movement amount including a horizontal component of the mobile apparatus and a vertical movement amount that is calculated on a basis of the measurement value of the absolute pressure sensor.

(13) The mobile apparatus according to (12), further including

a position calculation unit that calculates a current position of the mobile apparatus on the basis of the movement amount including the horizontal component of the mobile apparatus and the vertical movement amount.

(14) The mobile apparatus according to any one of (11) to (13), further including a Kalman filter,

in which the Kalman filter receives a plurality of different state values that changes with time transition, updates state values that have already been acquired on the basis of the newly received state values, and generates and outputs latest state values.

(15) The mobile apparatus according to (14), in which

an output value of the Kalman filter includes at least one of state values including

an inclination angle β of the mobile apparatus,

a traveling surface inclination angle α of the mobile apparatus, and

a current three-dimensional position (x, y, z) of the mobile apparatus.

(16) An information processing method executed in an information processing apparatus, the information processing method including:

receiving a tire air pressure as a measurement value of an air pressure sensor that measures an air pressure of a tire of a mobile apparatus; and

calculating an inclination of the mobile apparatus on the basis of the tire air pressure,

the receiving and the calculating being performed by a vehicle inclination calculation unit.

(17) An information processing method executed in a mobile apparatus, the information processing method including the steps of:

measuring, by an air pressure sensor, an air pressure of a tire of the mobile apparatus; and

receiving the tire air pressure as a measurement value of the air pressure sensor, and

calculating an inclination of the mobile apparatus on the basis of the tire air pressure,

the receiving and the calculating being performed by a vehicle inclination calculation unit.

(18) A program that causes an information processing apparatus to execute information processing including:

causing a vehicle inclination calculation unit to

receive a tire air pressure as a measurement value of an air pressure sensor that measures an air pressure of a tire of a mobile apparatus, and

calculate an inclination of the mobile apparatus on the basis of the tire air pressure.

Note that the series of processing described in the specification can be executed by hardware, software, or a composite configuration of both. In a case where processing is executed by software, a program where a processing sequence is recorded can be installed in a memory incorporated in dedicated hardware and provided within a computer and executed, or the program can be installed in a general-purpose computer capable of executing various types of processing and executed. For example, the program can be recorded in a recording medium in advance. The program can be installed in a computer from the recording medium, or can be received via a network such as a local area network (LAN) and the Internet, and installed in a built-in recording medium such as a hard disk.

In addition, the various types of processing described in the specification may be executed not only in time series as described, but also in parallel or individually according to processing abilities of the apparatuses executing the processing or as necessary. In addition, in the present specification, a system is a logical set configuration of a plurality of apparatuses and is not limited to a system in which apparatuses having respective configurations are present in the same housing.

### INDUSTRIAL APPLICABILITY

As described above, according to a configuration of an embodiment of the present disclosure, an information processing apparatus and a mobile apparatus that individually calculate an inclination of the mobile apparatus itself and an inclination of a traveling surface are achieved.

Specifically, for example, a measurement value of an air pressure sensor that measures an air pressure of a tire of the mobile apparatus is received, and the inclination of the mobile apparatus is calculated on the basis of the tire air pressure. Furthermore, a measurement value of an absolute pressure sensor attached to the mobile apparatus is received, and an angle of the traveling surface on which the mobile apparatus travels and a position of the mobile apparatus are calculated on the basis of a horizontal movement amount of the mobile apparatus and a vertical movement amount that is calculated on the basis of the measurement value of the absolute pressure sensor. Furthermore, a plurality of different state values such as inclination information of the traveling surface that changes with time transition is input to a Kalman filter, and state values that have already been acquired are updated on the basis of the newly input state values to generate and output the latest state values.

With this configuration, an information processing apparatus and a mobile apparatus that individually calculate an inclination of the mobile apparatus itself and an inclination of a traveling surface are achieved.

### REFERENCE SIGNS LIST

10 Vehicle
20 Acceleration sensor
30 Traveling surface
100 Vehicle
110 Information processing apparatus
111 Wheel encoder
112 Acceleration sensor
113 Absolute pressure sensor
114 Air pressure sensor
121 Wheel (Tire)
130 Load
201 Air pressure sensor
202 Wheel encoder
203 Absolute pressure sensor
204 GPS
205 Acceleration sensor
206 Gyro sensor
211 Tire model estimation unit
212 Vehicle inclination calculation unit
213 Integrator
214 Altitude calculation unit
215 Traveling surface inclination and vehicle position calculation unit
216 Attitude angle calculation unit
220 Storage unit
230 Kalman filter
301 CPU
302 ROM
303 RAM
304 Bus
305 Input/output interface
306 Input unit
307 Output unit
308 Storage unit
309 Communication unit
310 Drive
311 Removable medium

1. An information processing apparatus comprising a vehicle inclination calculation unit that
receives a tire air pressure as a measurement value of an air pressure sensor that measures an air pressure of a tire of a mobile apparatus, and
calculates an inclination of the mobile apparatus on a basis of the tire air pressure.

2. The information processing apparatus according to claim 1, further comprising
a traveling surface inclination calculation unit that
receives a measurement value of an absolute pressure sensor attached to the mobile apparatus, and
calculates an angle of a traveling surface on which the mobile apparatus travels on a basis of a movement amount including a horizontal component of the mobile apparatus and a vertical movement amount that is calculated on a basis of the measurement value of the absolute pressure sensor.

3. The information processing apparatus according to claim 2, further comprising
a position calculation unit that calculates a current position of the mobile apparatus on a basis of the movement amount including the horizontal component of the mobile apparatus and the vertical movement amount.

4. The information processing apparatus according to claim 1, wherein
the vehicle inclination calculation unit receives,
from the air pressure sensor,
an average of air pressures of front wheel tires of the mobile apparatus, and
an average of air pressures of rear wheel tires of the mobile apparatus,
calculates, on a basis of the received values, a spring constant of the front wheel tire and a spring constant of the rear wheel tire, and calculates the inclination of the mobile apparatus by using the calculated spring constants.

5. The information processing apparatus according to claim 1, wherein
the vehicle inclination calculation unit generates a balance equation of moments at a plurality of different portions of the mobile apparatus, and calculates the inclination of the mobile apparatus by using the generated balance equation of the moments.

6. The information processing apparatus according to claim 5, wherein
the moments are moments around a position of a load loaded on the mobile apparatus, and
include moments at three positions of the mobile apparatus, that is, a center of gravity position, a front wheel tire position, and a rear wheel tire position.

7. The information processing apparatus according to claim 1, wherein
a GPS measurement value or high-accuracy map information is acquired, and an angle of a traveling surface of the mobile apparatus or a current position of the mobile apparatus is calculated by using the acquired information.

8. The information processing apparatus according to claim 1, further comprising a Kalman filter,
wherein the Kalman filter receives a plurality of different state values that changes with time transition, updates state values that have already been acquired on a basis of the newly received state values, and generates and outputs latest state values.

9. The information processing apparatus according to claim 8, wherein
the Kalman filter receives a detection value of an acceleration sensor, and applies the received detection value of the acceleration sensor to calculate and output a latest state value.

10. The information processing apparatus according to claim 8, wherein
an output value of the Kalman filter includes at least one of state values including
an inclination angle β of the mobile apparatus,
a traveling surface inclination angle α of the mobile apparatus, and
a current three-dimensional position (x, y, z) of the mobile apparatus.

11. A mobile apparatus comprising:
an air pressure sensor that measures an air pressure of a tire of the mobile apparatus; and
a vehicle inclination calculation unit that
receives the tire air pressure as a measurement value of the air pressure sensor, and
calculates an inclination of the mobile apparatus on a basis of the tire air pressure.

12. The mobile apparatus according to claim 11, further comprising:
an absolute pressure sensor that measures an absolute pressure; and
a traveling surface inclination calculation unit that
receives a measurement value of the absolute pressure sensor, and
calculates an angle of a traveling surface on which the mobile apparatus travels on a basis of a movement amount including a horizontal component of the mobile apparatus and a vertical movement amount that is calculated on a basis of the measurement value of the absolute pressure sensor.

13. The mobile apparatus according to claim 12, further comprising
a position calculation unit that calculates a current position of the mobile apparatus on a basis of the movement amount including the horizontal component of the mobile apparatus and the vertical movement amount.

14. The mobile apparatus according to claim 11, further comprising a Kalman filter,
wherein the Kalman filter receives a plurality of different state values that changes with time transition, updates state values that have already been acquired on a basis of the newly received state values, and generates and outputs latest state values.

15. The mobile apparatus according to claim 14, wherein
an output value of the Kalman filter includes at least one of state values including
an inclination angle β of the mobile apparatus,
a traveling surface inclination angle α of the mobile apparatus, and
a current three-dimensional position (x, y, z) of the mobile apparatus.

16. An information processing method executed in an information processing apparatus, the information processing method comprising:
receiving a tire air pressure as a measurement value of an air pressure sensor that measures an air pressure of a tire of a mobile apparatus; and
calculating an inclination of the mobile apparatus on a basis of the tire air pressure,
the receiving and the calculating being performed by a vehicle inclination calculation unit.

17. An information processing method executed in a mobile apparatus, the information processing method comprising the steps of:
measuring, by an air pressure sensor, an air pressure of a tire of the mobile apparatus; and
receiving the tire air pressure as a measurement value of the air pressure sensor, and
calculating an inclination of the mobile apparatus on a basis of the tire air pressure,
the receiving and the calculating being performed by a vehicle inclination calculation unit.

18. A program that causes an information processing apparatus to execute information processing comprising:
causing a vehicle inclination calculation unit to
receive a tire air pressure as a measurement value of an air pressure sensor that measures an air pressure of a tire of a mobile apparatus, and
calculate an inclination of the mobile apparatus on a basis of the tire air pressure.
